(19) United States
(12) Patent Application Publication
(10) Pub. No.: US 2025/0087691 A1
(43) Pub. Date: Mar. 13, 2025

(54) SACCHARIDE-BASED BINDER SYSTEM FOR ULTRA-LONG LIFE AND HIGH CAPACITY LITHIUM-SULFUR BATTERY

(71) Applicant: Monash University, Clayton (AU)

(72) Inventors: Yingyi HUANG, Clayton (AU); Mahdokht SHAIBANI, Clayton (AU); Matthew HILL, Clayton (AU); Mainak MAJUMDER, Clayton (AU)

(73) Assignee: Monash University, Clayton (AU)

(21) Appl. No.: 18/580,654

(22) PCT Filed: Jul. 18, 2022
(86) PCT No.: PCT/AU2022/050759

§ 371 Date: Jan. 19, 2024

(30) Foreign Application Priority Data
Jul. 21, 2021 (AU) 2021902246

(51) Int. Cl. H01M 4/62; H01M 10/0525

(52) U.S. Cl. CPC H01M 4/621; H01M 10/0525

(57) ABSTRACT

Stability to long term charge and discharge cycles is the most formidable challenge for Lithium-Sulfur batteries. Therefore, a more holistic design of a durable cathode with minimal polysulfide escape to mitigate the corrosion of the lithium anode is required. A saccharide-based binder system—the monosaccharide (glucose) component, on account of being a strong reducing agent has a unique capacity for the regulation of polysulfide thereby dramatically enhancing the functionality of a polysaccharide (carboxymethyl cellulose) binder system. The two-component binder system promotes the formation of viscoelastic filaments during casting which endows sulfur cathode a desired web-like microstructure. The combination of these effects leads to 97% sulfur utilisation with an ultra-long cycle life of 1000 cycles (9 months) and a high capacity retention (around 700 mAhg⁻¹ after 1000 cycles). A pouch cell prototype with a capacity of 1200 mAhg⁻¹ demonstrates a promising transition from laboratory to manufacturing options.

### FIELD OF THE INVENTION

The present invention relates to Lithium-Sulfur batteries, and in particular a saccharide based binder system with improved polysulfide regulation ability porosity resulting in outstanding cycling ability.

### BACKGROUND TO THE INVENTION

Lithium-ion batteries (Li-ion) have changed the world. But as society moves away from fossil fuels, we will need competing new battery chemistries for storing energy to support renewable electricity generation, electric vehicles and other needs¹. At the same time, the viability of many emerging technologies for example in aviation require lighter-weight batteries, i.e., more energy dense batteries. One such technology could be lithium-sulfur batteries (Li—S): in theory, they store as much as five times the energy for a given weight than Li-ion and the realizable specific energy of the future Li—S battery will likely fall in the range of 400-600 Wh kg⁻¹. They can be made from materials that are readily and sustainably available around the world. Until now, the realization of Li—S batteries has been challenging, mainly due to the instability of both electrodes which results in a short cycle life of the battery. The power performance of the Li—S system is also inherently slow, particularly when the sulfur cathode is loaded to the required levels mainly due to poor ion diffusion across the thickness of the cathode.

Extensive research over the past ten years has provided for marked improvements in the sulfur cathode as well as a profound understanding of the failure mechanisms²⁻⁶. In 2010, Nazar et al., carried out pioneering research in the area of composite sulfur cathodes and addressed the challenge of low-electrical conductivity of the sulfur cathode⁷. Later on, they pioneered the introduction of polysulfide absorbents and mediators to the composition of the sulfur cathode and addressed the issue of “polysulfide shuttle” to a large extent⁸. Quite recently, the applicants have addressed the challenge of the structural instability of cathode, by introducing the expansion-tolerant architecture⁹. However, the problem of achieving high capacity simultaneously with large cycle life has largely remained unsolved.

In stark contrast with Li-ion battery, the Solid Electrolyte Interphase (SEI) layer on the anode of Li—S battery, while easily formed, also easily cracks as a result of the constant attack of polysulfides as well as the large stress evolution in the cell, leaving the freshly formed lithium surface in dynamic exchange with the polysulfide containing electrolyte¹⁰. The continuous reformation of the SEI is accompanied by the continuous consumption of the electrolyte. Eventually, the cell dries up and fails-presenting the biggest challenge of the Li—S battery chemistry.

Li—S cycle life can be improved with the cathodes that could simultaneously accommodate the volume change and confine the polysulfides. To date several binder systems, such as natural gums (ex., gum Arabic¹¹, guar gum, and xanthan gum¹²) and cellulose based binders (ex., CMC/SBR¹³, cross-linked CMC-Citric acid¹⁴, and Na-alginate¹⁵) have been explored to assist with the volume change. From these studies it can be inferred that cellulose-based binders serve well in fabricating mechanically robust cathodes. Furthermore, novel binder systems have been critically designed to add polysulfide absorbing functionality to the binder such as the electroactive nanocomposite binder composed of polypyrrole and polyurethane (PPyPU)¹⁶, and modified cyclodextrin (C-β-CD)¹⁷. The general conclusion from such studies for targeted retarding the shuttle of polysulfides is that binders with polar/electronegative functional groups can serve better in the sulfur cathode¹⁶. Unfortunately, despite superiority over the traditionally used PVDF, these translations have not resulted in reasonably stable Li—S batteries over long-term cycling and at a pouch cell prototype level because the efficient binder system should demonstrate a combination of properties to make cathodes perform at their most desirable level. The new cathode design provides, at the same time, expansion tolerance functionality, strong polysulfide crossover limitation, and ion diffusion highways via nano-structuring—and it can be fabricated at scale from commonly sourced materials. These beneficial properties holistically mitigate the damage to the lithium metal anode, from which short circuits typically originate, ending the cycle life. The superior behaviour of these cathodes is emphasized by post-mortem analysis on the lithium anode of heavily cycled cells. This demonstrated the lithium protection capabilities of the new cathode that in turn delivered 1000 stable cycles over 9 months of continual operation.

The applicants' current work is inspired by a 1988 geochemistry report¹⁸ that described how two saccharide-based substances, namely glucose and to a lesser extent, cellulose, resist degradation in geological sediments by forming strong organo-sulfur bonds with polysulfides and hydrogen sulfide. Built on the strong binding ability of the high-modulus carboxymethyl cellulose (CMC) binder^{19,20}, and the stronger ability of glucose for polysulfide regulation, a saccharide-based co-binder system is introduced which not only enables the fabrication of mechanically robust cathodes but also endows strong polysulfide confinement functionality. More importantly, a saccharide-based aqueous slurry promotes the formation of a web-like electrode microstructure. This can be rationalized by the viscoelastic filament thinning of the non-Newtonian binder systems and shaped by competing capillary forces and viscous drag. The result of the micro-architectural design leads to a segregated structure which rises to the challenge of stress evolution.

These synergistic effects are exploited to deliver an incredible 97% sulfur utilisation with an ultra-long cycle life of 1000 cycles and a high capacity retention (1106 mAhg⁻¹ even after 500 cycles and around 700 mAh g⁻¹ after 1000 cycles) while achieving >99% columbic efficiency—a clear demonstration of mitigating the damage on the lithium metal anode. To demonstrate the robustness of the binder system, cathodes were manufactured with a high loading of 10.5 mg cm⁻²,achieving an areal capacity of 12.56 mAh cm² with >98% efficiency. A pouch cell prototype with capacity around 1200 mAhg⁻¹ demonstrates a promising transition from laboratory to industry application.

The object of this invention is to provide a saccharide based binder system with improved polysulfide regulation ability porosity resulting in outstanding cycling ability to alleviate the above problems, or at least provide the public with a useful alternative.

### SUMMARY OF THE INVENTION

To date, the main function expected from different binders used in the fabrication of sulfur cathodes has been to glue the carbon and sulfur together and make crack-free structures. We have shown that a simple saccharide-based binder system can impart two critical functionalities to a non-sophisticated sulfur cathode, polysulfide regulation ability and inducing porosity, and as a result leads to an outstanding cycling stability.

The significant contributions of glucose can be summarised into two aspects. Firstly, glucose, being a strong reducing agent, enables the conversion of higher order LiPS to lower order LiPS, while also enhancing the LiPS retention capacity—these properties improve the battery chemistry by slowing polysulfide shuttling. Secondly, glucose has a strong role as a viscosity modifier of the binder liquid, with order-of-magnitude changes recorded. This allows the viscoelastic filaments to be desirably shaped during a typical electrode formation process. By fine tuning the microstructure for improved electrolyte access and ion transport properties, alongside increased polysulfide retention capacities, our CMC/G cathodes show dramatically enhanced capacities and cycle life. We offer generic insights into how the mechanically strong segregated structures can be guided by the choice of viscoelastic features and criterion of the fluid properties. The combination of the optimal chemical and mechanical aspects of the binder chemistry leads to significantly enhanced Li—S batteries with ultra-high specific capacity and ultra-long cycle life of 1629 mAhg⁻¹ and 1000 cycles, respectively. The pouch cell prototype indicates that our approach of using water-based electrode slurries with tailored polysaccharide binders offers an environmentally benign and cost-efficient approach to produce high performance sulfur cathodes with tremendous potential for immediate translation to industrial production.

More specifically, in a first aspect the invention provides a binder system for the cathode of a Lithium-Sulfur battery, the binder comprising a polysaccharide in combination with a monosaccharide.

Preferably the monosaccharide is glucose, and the polysaccharide is carboxy methyl cellulose.

In preference the binder comprises approximately ⅔ carboxy methyl cellulose and ⅓ glucose by weight.

Preferably the cathode comprises Sulfur, Carbon, and binder in the ratios by weight of approximately of 70% Sulfur, 20% Carbon and 10% binder.

In preference the cathode is made by the steps of: a) dry mixing the Sulfur and the Carbon to form a mixture; b) stirring the mixture; c) adding the carboxy methyl cellulose and glucose to the mixture; d) stirring the mixture; e) adding de-ionised water to the mixture to form a slurry; and f) forming the slurry into a cathode.

The invention also provides a Lithium-Sulfur battery comprising a cathode as described above, a Lithium anode, a separator and a carbon nanotube paper interlayer.

It should be noted that any one of the aspects mentioned above may include any of the features of any of the other aspects mentioned above and may include any of the features of any of the embodiments described below as appropriate.

### BRIEF DESCRIPTION OF THE DRAWINGS

FIG. 1 provides a simulation of LiPS adsorption. (a) Adsorption conformations and binding energies for Li₂S₄, Li₂S₆, and Li₂S₈ on glucose. (b) Binding energy comparison for glucose and the commonly used PVDF binder2215 with various LiPS species, demonstrating the superior capacity of glucose for adsorbing polysulfides.

FIG. 2 shows adsorption conformations and binding energies for Li₂S₄, Li₂S₆, and Li₂S₈ on glucose (other two possible binding sites).

FIG. 3 provides a Polysulfide interaction study. Absorption tests via UV-Vis. a) Evolution of polysulfide with glucose in DOL/DME electrolyte solution; b) UV-Vis spectrum of Li₂S₆ with glucose in DOL/DME electrolyte solution after a specific time; c) Comparison of LiPS absorption between CMC and glucose. d) and e) Illustrating the evolution of polysulfide in the presence of high concentrate lithium polysulfide; f) Raman spectra of suspensions and g) FTIR spectra of washed solid residues.

FIG. 4 shows adsorption conformations and binding energies for Li₂S₄, Li₂S₆, and Li₂S₈ on CMC. The binding energies with CMC (0.74-0.76 eV) are relatively lower than the binding energies with glucose (0.90-0.95 eV), but the difference is not obvious when compared to the experimental absorption test. We attribute this inconsistency with experiments to several plausible reasons: (a) In experiments, kinetics of LiPS diffusion is likely to be very different for glucose and CMC. However, this aspect is ignored in our calculations, which simply estimate the strength of binding interactions. (b) The calculations for binding energy assume an ideal geometry at the atomic scale, assumptions that may not hold when comparing with experiments.

FIG. 5 is a ¹H NMR analysis probing the glucose-Li₂S₆ interactions within a simulated battery environment. a) Full ¹H NMR spectrum for the glucose/Li₂S₆ composites. b) The proportion evolution between H_{1α}and H_{1α}′ over 8 days. c) ¹H NMR spectra over 8 days.

FIG. 6 shows UV-Vis spectrum of Li₂S₆ with CMC in DOL/DME electrolyte solution after certain time and evolution of CMC with Li₂S₆ in DOL/DME electrolyte solution.

FIG. 7 provides a microstructure study, elemental mapping and schematic illustration of the sulfur electrode with the different binder systems. Top-view SEM images and schematic illustration of the architecture in sulfur cathodes with different binders. a-c) pure CMC as the binder, demonstrating a cohesive network of agglomerated particles being trapped in the network of the binder; d-f) CMC+G as the binder, illustrating a segregated structure that separated particles linked by web-like binders. Cross-sectional SEM images and elemental mapping of cathodes with different binders. g-i) pure CMC as the binder, demonstrating a continuous binder film covering on the surface of particles; j-l) CMC+G as the binder, illustrating the existence of bridging bonds across the electrode and excellent sulfur exposure.

FIG. 8 shows visible cells with lithium anode and sulfur cathode immersed in electrolyte after cycling. a) CMC/G cathode and b) CMC cathode.

FIG. 9 presents a mechanical analysis of the binders. a) Density of powder mixture including sulfur, carbon and binder, and porosity of the final electrode among four different cases. b) Tensile test and indentation test of cathodes with CMC+G and pure CMC as binder. c) Steady-state shear flow behaviour. Peeling test d) Force versus displacement plots of the peeling test among four samples; e-f) Photos of the peeling test setup and i-l) Microstructures of binder for corresponding samples.

FIG. 10 illustrates Raman and FTIR test. a) Raman spectra for liquid LiPS reactant. b) FTIR spectra for binder ingredients. c) Full FTIR spectra for residue samples. d) FTIR spectrum for liquid LiPS.

FIG. 11 is a cycling performance comparison between CMC cathode and CMC/G cathode. a) The electrodes with 3 mg cm⁻² sulfur loading, and batteries cycling under 0.2 C; b) 6.5 mg cm⁻² sulfur loading and 10.5 mg cm⁻² sulfur loading shows in the insert plot. c) Rate capability data among two compared samples (2 mg cm⁻² sulfur loading), red lines indicate the performance of CMC/G cathode, and the brown lines indicate the performance of CMC cathode. d) Areal and specific capacity as a function of sulfur loading. The error bar (standard deviation) of each data point was calculated based on the cycle performance of three coin cells with similar sulfur loadings. e) Comparative analysis of the areal capacity and total gravimetric capacity of the cathodes after 500 cycles in noteworthy literatures^{2,43-55}. Configuration of the pouch cell with f) single-sided cathodes g) double-sided cathodes, and lean electrolyte condition (E/S=5 μL mg⁻¹), optimised for energy density.

FIG. 12 shows an in depth ¹H NMR analysis of the glucose-Li₂S₆ interaction within a simulated battery environment.

FIG. 13 details Electrochemical characterisation on sulfur cathodes with two different binder system. Cyclic voltammogram profiles. a) CV profiles comparison; CV profiles at different scan rates of lithium sulfur batteries with b) CMC/G cathode and c) CMC cathode; d) The linear fits of the CV peak currents for the lithium sulfur batteries with CMC/G cathode (A₁, B₁, C₁) and with CMC cathode (A₂, B₂, C₂). Charge/discharge profiles corresponding of lithium sulfur batteries with e) CMC/G cathode and f) CMC cathode. Electrochemical impedance spectroscopy g) Nyquist plots of the lithium sulfur batteries with CMC/G and CMC cathodes before and after 80 cycles; h) Nyquist plot and equivalent circuit analysis of batteries after cycling.

FIG. 14 shows cross-section of cathodes with a) Pure CMC, b)

$$\frac{2}{3} CMC + \frac{1}{3} G ,$$

c) Pure glucose and d)

$$\frac{1}{2} CMC + \frac{1}{2} G$$

and as binder.

FIG. 15 illustrates Post-mortem of lithium metal anode and sulfur cathode after an intense cycling regime. Top-view SEM image of lithium metal coupling with a) CMC cathode and b) CMC/G cathode. Cross-sectional observation and elemental mapping of c-e) CMC cathode and f-h) CMC/G cathode at full charge state.

FIG. 16 shows cycle performance of electrodes with different binders.

FIG. 17 illustrates power law calculation of a) Pure CMC, b)

$$\frac{2}{3} CMC + \frac{1}{3} G ,$$

c)

$$\frac{1}{2} CMC + \frac{1}{2} G$$

and d) Pure glucose cathode slurries.

FIG. 18 shows viscoelastic properties of the slurries a) Power law index n and consistency coefficient K (represents limit of viscosity of fluid at an infinite shear stress) of the cathode slurries determined using the power law. b) Amplitude sweep measurements and c) frequency sweep measurements of four different sulfur cathode slurries. d) Amplitude sweep measurements of CMC binder with different solid content in water. e) Zero-shear-rate viscosity and f) Surface tension of four binders.

FIG. 19 provides SEMs of sulfur cathode for binder filaments initial radius calculation and histograms of binder filaments initial radius with the Gaussian distribution fitting.

FIG. 20 shows EDX mapping of sulfur cathode with

$$\frac{2}{3} CMC + \frac{1}{3} G$$

as binder.

FIG. 21 shows an XRD of electrode and associated components.

FIG. 22 is a schematic presentation of: a) cells configured with carbon coated glass fibre; b) cell configured with CNT paper interlayer.

FIG. 23 illustrate discharge capacities of various coin cell configurations.

FIG. 24 demonstrates applications of CNT interlayer.

FIG. 25 is a comparison of two different pouch cells.

FIG. 26 shows electrochemical characterisation of pure glucose cathodes.

FIG. 27 tabulates mean radius and standard deviation of distribution curves for the four binder filaments.

FIG. 28 tabulates density measurements of the four binders.

FIG. 29 details cycle performance comparison.

FIG. 30 tabulates a summary of E/S ratio (μL mg−1) based on different interlayer configurations, sulfur loadings and cell types.

### DETAILED DESCRIPTION OF THE INVENTION

The following detailed description of the invention refers to the accompanying drawings.

The invention provides a binder system for lithium—Sulfur batteries comprising a polysaccharide in combination with a monosaccharide. The following description describes the use of glucose for the monosaccharide. Other monosaccharides such as sucrose may also be used with lesser results.

### Superior ability of glucose for polysulfide regulation

In stark contrast with the energy delivery mechanism in Li-ion, the liquid electrolyte and the sulfur cathode almost act like a couple to form the highly soluble polysulfide species, causing the well-known shuttle phenomenon. The weak nature of the physical interaction between the polar polysulfides and nonpolar fillers (carbon and binder materials)²¹ in a typical sulfur cathode cannot retard the shuttling effect over long-term cycling, a call for further functionalities to be incorporated into the cathode design. Here, we show that a saccharide-based binder system provides such functionalities.

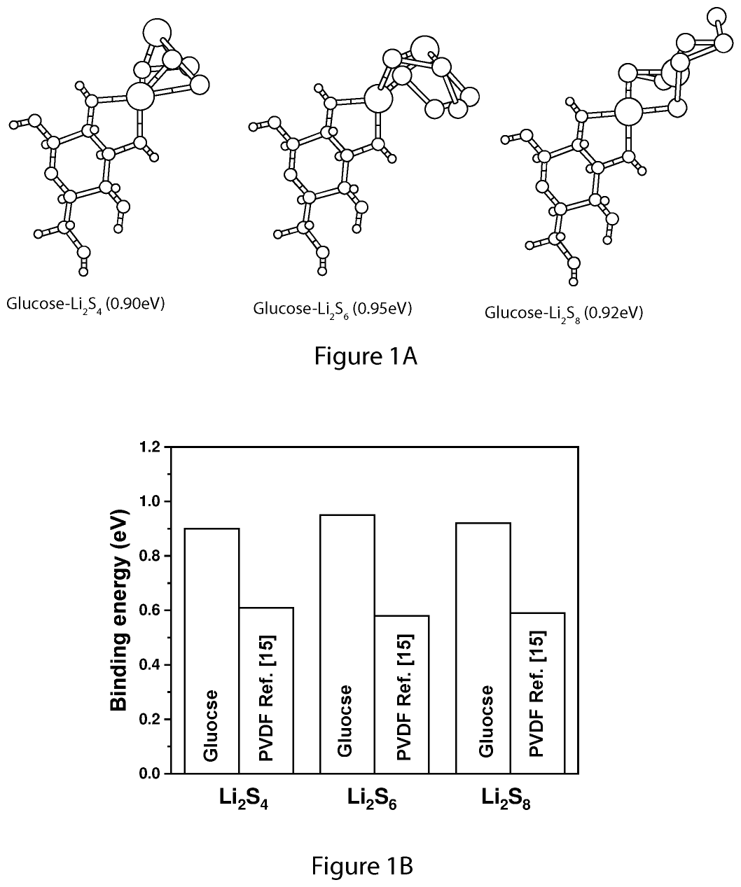

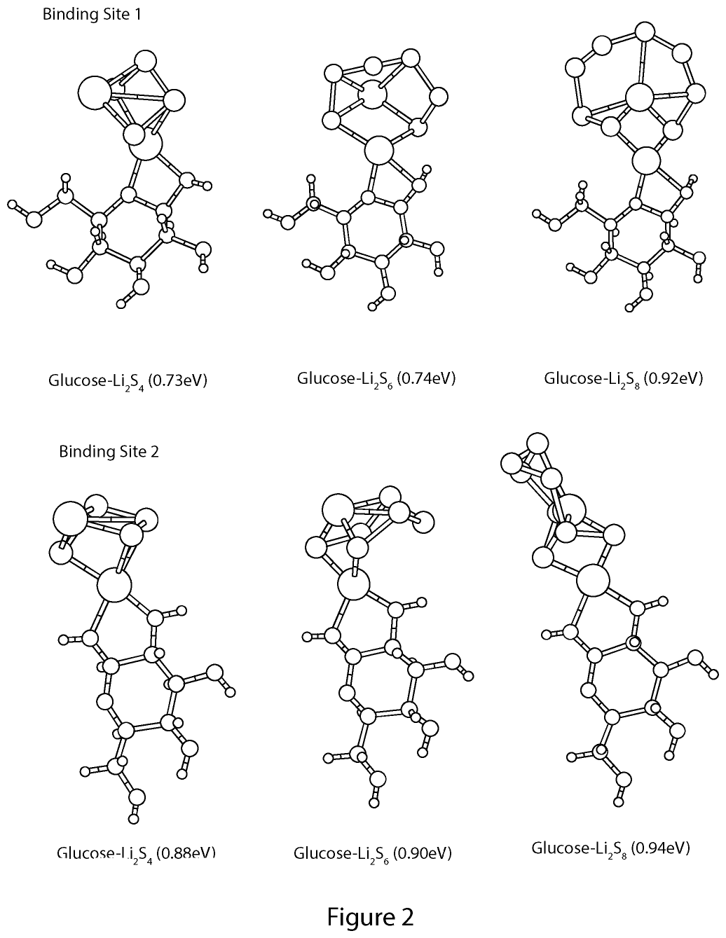

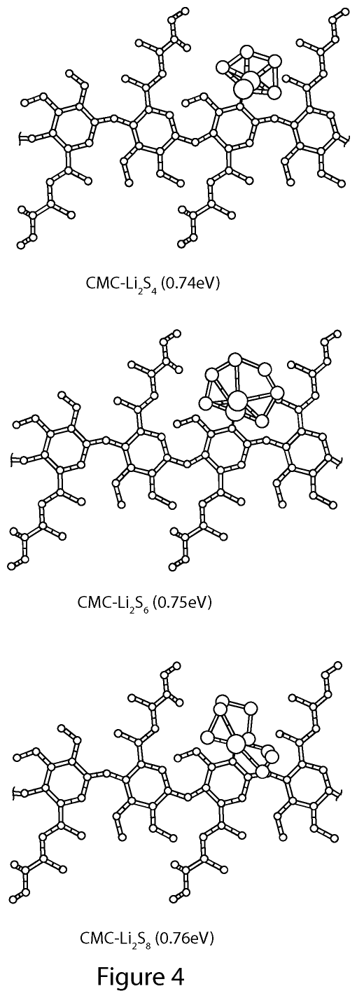

In order to gain an understanding of the interaction between saccharide-based binders and lithium polysulfides (LiPS), ab initio simulations performed in the framework of density functional theory were carried out to investigate the adsorption of LiPS species on glucose. As shown in FIG. 1, a strong interaction with LiPS and hydroxyl groups within the binders was observed. In all these coordination complexes (glucose and LiPS), the most stable configuration corresponds to lithium binding directly to oxygen atoms and forming lithium-oxygen bonds, with binding energies of 0.90 eV for glucose-Li₂S₄, 0.95 eV for glucose-Li₂S₆ and 0.92 eV for glucose-Li₂S₈. Other two possible binding sites in glucose were considered and summarized in FIG. 2 have binding energies from 0.72 to 0.94 eV. Compared to the binding energy between the same LiPS species and commercially available binder for Li—S battery—polyvinylidene fluoride (PVDF), the total binding energies range from 0.58 to 0.61 eV²², much lower than those of glucose. The binding energies and corresponding adsorption conformations between CMC and LiPS also calculated and demonstrated in FIG. 4.

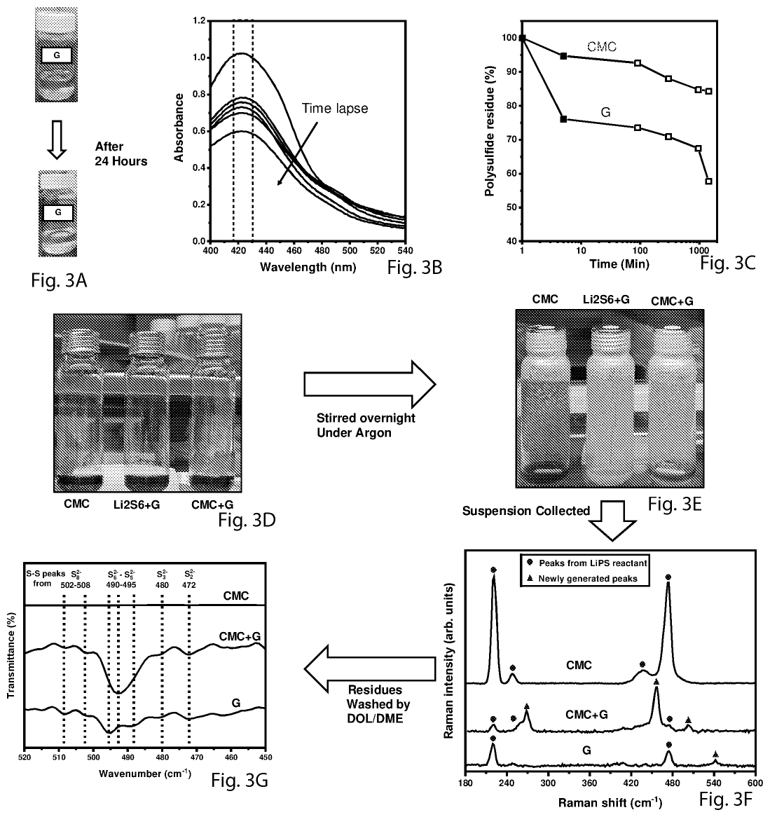

To further examine the ability of saccharide-based materials for LiPS regulation, several comparative tests were carried out with glucose and CMC in presence of LiPS solution. Ultraviolet-visible spectroscopy (UV-Vis) detected the residue concentration of polysulfide after different incubation times. The peak of LiPS was detected at a wavelength around 420 nm in agreement with literature²³. The results (FIG. 3a to c) showed that 42% of polysulfide eventually adsorbed in the presence of glucose, compared to only 16% in CMC with the same weight percentage of absorbent (FIG. 6), demonstrating almost three times more capacity for LiPS absorption. In addition, two visible Li—S cells were assembled, shown in FIG. 8, the difference of electrolyte colour in two cells after cycling were apparent, which demonstrate the superior ability of the CMC/G cathode to retain LiPS.

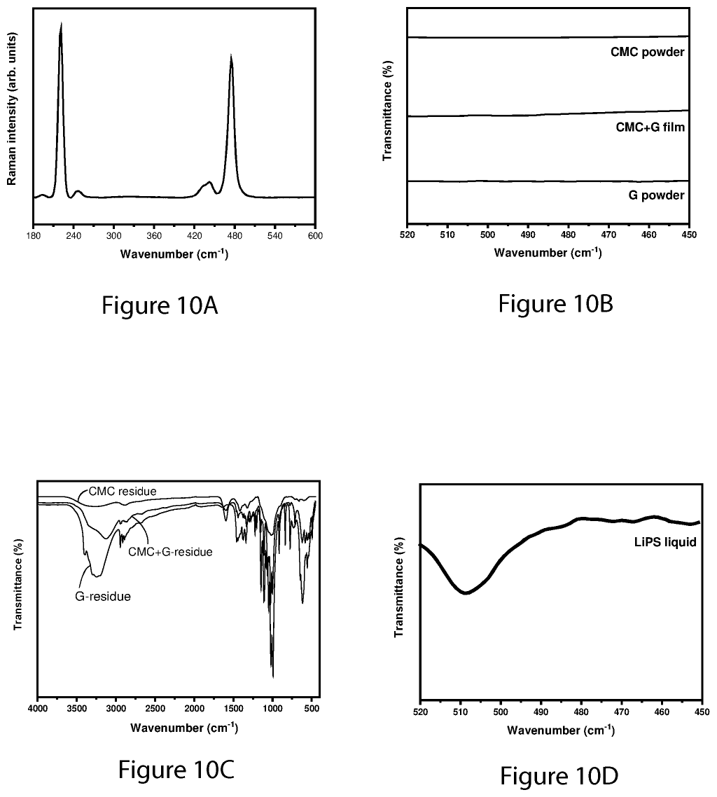

Further analysis was carried out on the suspension obtained from the reactions between a highly concentrated LiPS solution and glucose, CMC/G, and CMC composition to uncover the possible role of glucose in the polysulfide reducing reactions. FIG. 3d to e shows the vials after overnight incubation. These suspension samples were drop cast on glass slides, dried under Ar inside the glove box and collected for Raman spectroscopy analysis to study polysulfide speciation. Four peaks can be found in the LiPS+CMC sample (FIG. 3f, brown line). The peaks at 221 cm⁻¹ and 472 cm⁻¹, can be attributed to unreacted crystalline sulfur (S_{8, solid})²⁴ from LiPS synthesis and peaks at 247 cm⁻¹ and 435 cm⁻¹ are related to higher order LiPS (Li₂S₆ and Li₂S₈)²⁵⁻²⁷ in agreement with the literature. A control sample of the high concentration LiPS was examined under Raman spectroscopy (FIG. 10a), which showed peaks similar to the LiPS+CMC sample. This comparison demonstrates that the CMC, as expected, cannot carry forward the reducing reactions of higher order LiPS to the lower orders ones. In contrast, the spectra of glucose containing samples show reduced intensity of these four peaks, indicating lower content of elemental sulfur or high order LiPS. In stark contrast, new peaks in LiPS+CMC+G sample spectrum can be observed at 268 cm⁻¹, 503 cm₋₁ and 457 cm₋₁ that are associated with S₄²⁻, S₄⁻and S₆²⁻respectively¹⁸⁻²⁶, and in the spectrum of LiPS+G sample, the peak at 542 cm⁻¹ can be attributed to S₃^{·-24,28}. The presence of newly generated lower order LiPS in the glucose containing samples (LiPS+G and LiPS+CMC+G residues) conveys the strong ability of glucose to encourage the conversion of higher order LiPS to lower order more reduced LiPS, given that glucose is a well-known reducing agent²⁹. These functions are often linked with high capacity and enhanced capacity retention³⁰.

Further analysis was undertaken using Fourier transform infrared (FTIR) spectroscopy, which provides information on different LiPS species by monitoring the vibrational modes of S—S bonds³¹. The suspensions were vacuum filtered and the solid residues were collected. These solid residues were substantially washed with DOL/DME to remove higher order soluble LiPS or weakly bonded LiPS to CMC or glucose. After drying under vacuum, FTIR spectroscopy was performed on dry solid residues. The peaks of LiPS species³² can be observed primarily between 450 cm⁻¹-520 cm⁻¹. As shown in FIG. 3g, the spectrum is conspicuous by the absence of S—S peaks in the LiPS+CMC solid residue. This could be a result of weak interaction between LiPS and CMC, which causes the LiPS to wash away while collecting the solid residue. In contrast, in the samples, which contained glucose (LiPS+G and LiPS+CMC+G solid residue samples), the S—S vibrational modes can be observed for a range of LiPS species. The peaks at 502 cm⁻¹ and 508 cm⁻¹ can be attributed to S₈²⁻species³¹, while those at 490 cm⁻¹-495 cm⁻¹ are attributed to S₆²⁻and S₅²⁻species³¹ and at 480 cm⁻¹ and 472 cm⁻¹ are due to the presence of S₃²⁻and S₂²⁻in agreement with the previous reports^{31,33}. As expected, control FTIR analysis on CMC powder, glucose powder and CMC+G composite film (FIG. 10b), didn't show any peaks in the range of 450 cm⁻¹-520 cm⁻¹. This demonstrates that the peaks observed in glucose containing samples are due to the interactions between glucose and LiPS species. As a control, the FTIR spectrum of higher order LiPS solution is shown in FIG. 10d.

Utilizing three independent techniques viz. Raman, FTIR, and UV-Vis spectroscopies, we showed that the monosaccharide (glucose) has a distinct role in enhancing the polysulfide adsorption and interaction capacity compared to the polysaccharide (CMC) alone. We attribute this to the increased and more accessible active reaction sites compared to its polymeric counterpart, since compared to CMC, glucose is a monomer and has more free binding sides with higher degrees of freedom, which means it is more chemically active than CMC. In addition, the enhanced conversion of higher order to lower order LiPS, as evident by Raman and FTIR, is expected to improve the battery chemistry by slowing down the shuttling effect of polysulfides.

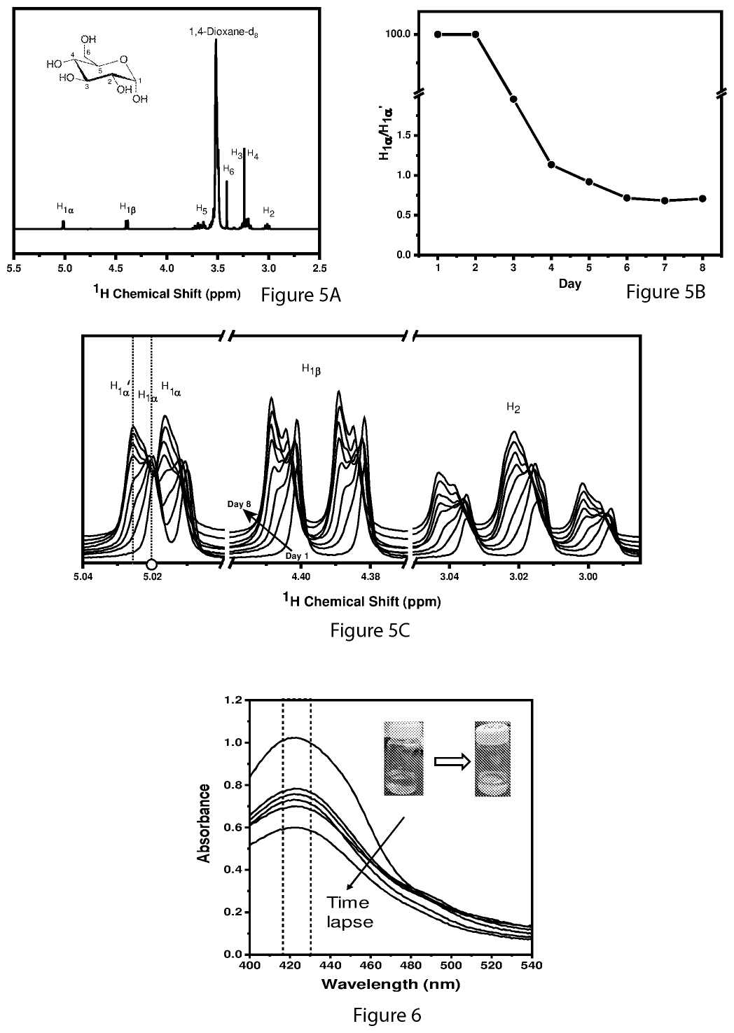

To further study the interaction between polysulfide and glucose, in-situ Nuclear magnetic resonance (NMR) experiments were conducted on CMC/glucose powders in presence of lithium polysulfide in dioxane-d₈ solvent for 8 days to simulate battery environment. The full ¹H NMR spectrum for the glucose and lithium polysulfide composites is shown in FIG. 5a. It confirms that the signals received primarily originate from the glucose binder present. ¹H NMR spectra were collected over 8 days as reported in FIG. 5c. A downfield shift is observed across all signals, indicating increased interaction with electron withdrawing groups as the battery reactions proceeded, and is strongest for peaks H₁ and H₂, indicating the site of this interaction. The modelling highlighted in FIG. 1 and binding side 2 in FIG. 2 indicated H₁ and H₂ as the preferred sites for intercalation of lithium polysulfides, in strong agreement with the NMR results. This shift was quantified by an in-depth examination of the H_{1α}signal, as shown in FIG. 5b and c. Fitting of the integrated peaks revealed a significant growth in the lithium polysulfide coordinated analogue, denoted as H_{1 α}′ that stabilised after 6 days. These results confirm that glucose plays an active role in the immobilisation of polysulfides, and contributes to the increased lifetime of the battery.

### Fabrication of Mechanically Robust Cathode With a Web-Like Structure

Adhering to the traditional cathode processing methods and commonly sourced materials, we manufactured our cathodes by mixing carbon black, crystalline sulfur and different proportions of CMC and glucose as the binder system in deionized (DI) water. To bring the innovative binder formulation into context, we notice that CMC is a commonly used binder in the fabrication of battery electrodes. Our recent work demonstrates that controlling the dispersion of CMC enables the formation of mechanically strong bridging bonds between the colloidal sulfur particles and conductive carbon to produce cathodes with a unique expansion-tolerant (ET) architecture⁹. This design, while very effective in terms of accommodating the cycling stress, has limited contribution in regulating the shuttle of polysulfides. As such, the damage on the lithium as a result of the constant attack of the polysulfide is inevitable and the batteries cannot perform to their high capacity over long term cycling. This calls for significantly more functionality to be introduced to the cathode from the binder, other than only assisting with the stress management.

We fabricated four types of sulfur cathodes with identical fractions of the components [70 wt. % sulfur, 20 wt. % C, and 10 wt. % binder system] yet using different fractions of glucose/CMC in the binder system, as explained in Table 1.

TABLE 1
Description of the cathodes with different binder systems

| | Ingredients and Proportion | | | | |
|---|---|---|---|---|---|
| | | | | | Zero-shear- |
| | | | | | rate |
| | | Glucose | Sulfur | | Viscosity of |
| Code | CMC | (G) | (S) | Carbon(C) | Binder (Pa · s) |
| Pure CMC | 10% | 0 | 70% | 20% | 736 |
| (common | | | | | |
| practice) | | | | | |
| $\frac{2}{3} CMC + \frac{1}{3} G$ | 6.67% | 3.33% | | | 8.23 |
| (our work) | | | | | |
| $\frac{1}{2} CMC + \frac{1}{2} G$ | 5% | 5% | | | 0.73 |
| (control | | | | | |
| experiment) | | | | | |
| Pure G | 0 | 10% | | | 0.06 |
| (control | | | | | |
| experiment) | | | | | |

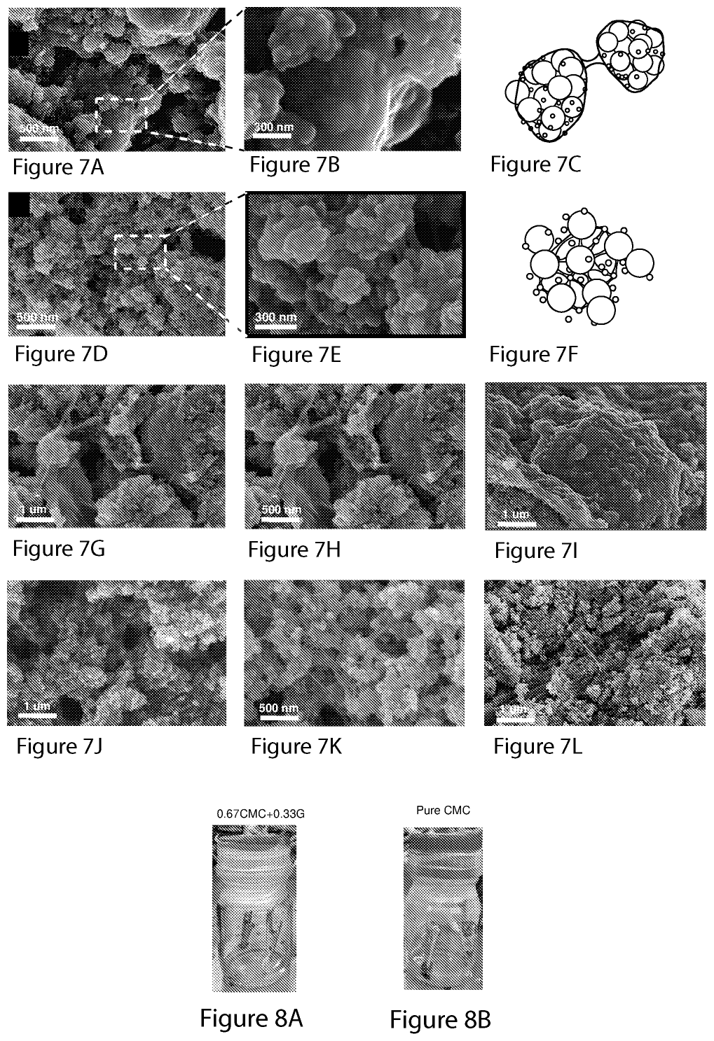

We conducted detailed scanning electron microscopy (SEM) studies at a wide range of magnifications to investigate the morphology of these cathodes. FIG. 7a to c illustrates a typical CMC-based cathode architecture. As evident in FIG. 7a and b, and as shown in the schematic figure (FIG. 7c), the cling wrap-like binder film covers active and conductive particles over a large area. For a desired architecture of the electrode, all active particles should be uniformly distributed within the conductive network of the electrode to enable homogeneous utilization of the active material. Further, to allow for facilitated electrolyte penetration, uniformly distributed low-resistance internal pathways are also critical³⁴. In stark contrast with the CMC-based cathode, the cathode with CMC+G binder system displays an advantageously more segregated structure (FIG. 7d to f for the top view and j to l for the cross-sectional SEM). Sulfur and carbon are exposed to a large extent owing to dispersed particle-level link instead of an agglomerated network. This web-like structure endows the sulfur cathode with the maximum exposure of the active materials, enhanced electrolyte accessibility and low resistance as well as short internal pathways for lithium ion transfer.

The cross-sectional SEM image and energy dispersive X-ray (EDX) mapping (FIG. 7g to i) of the same electrode also provides evidence of the continuous coverage of CMC binder over particles, which blocks off vital transport pathways.

### Mechanistic Insight and Viscoelastic Analysis of the Saccharide-Based Binder System

To obtain a mechanistic insight into the cathode microstructure, we quantified the critical physical properties of both the slurry and the coating. The apparent density of four different cathode mixtures was measured by gas pycnometer. The following equation³⁵ was employed for estimating the porosity of the electrode.

$$ρ = \frac{V ( cathode ) - {V}_{dense} ( cathode )}{V ( cathode )} \qquad Equation 1$$

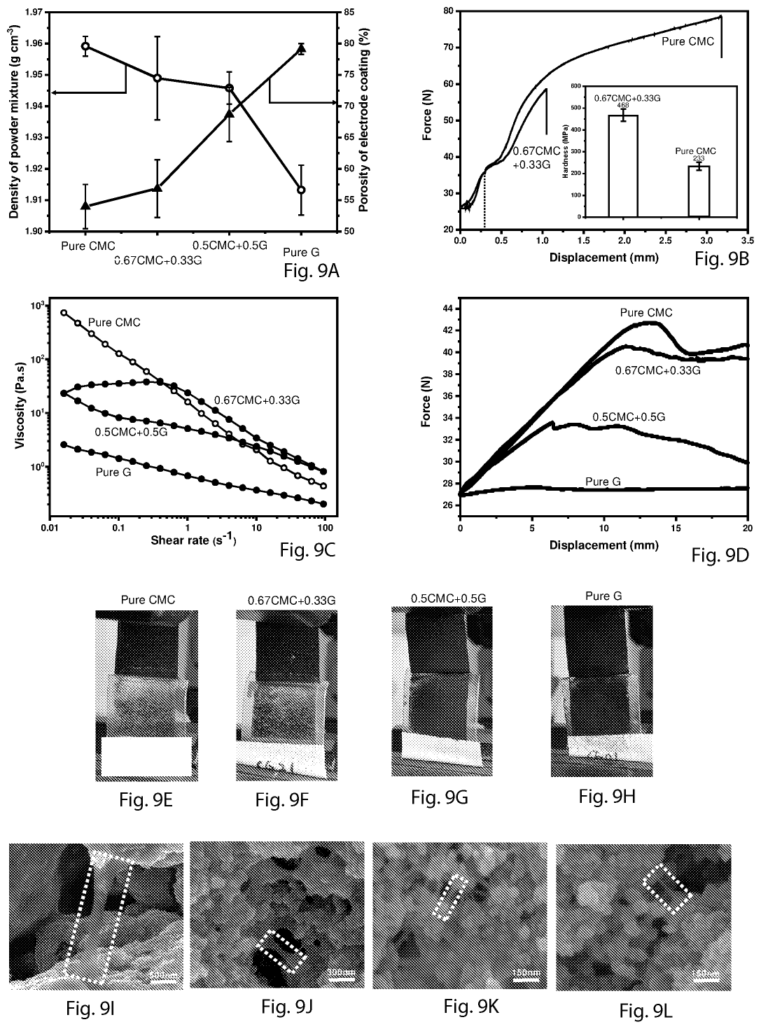

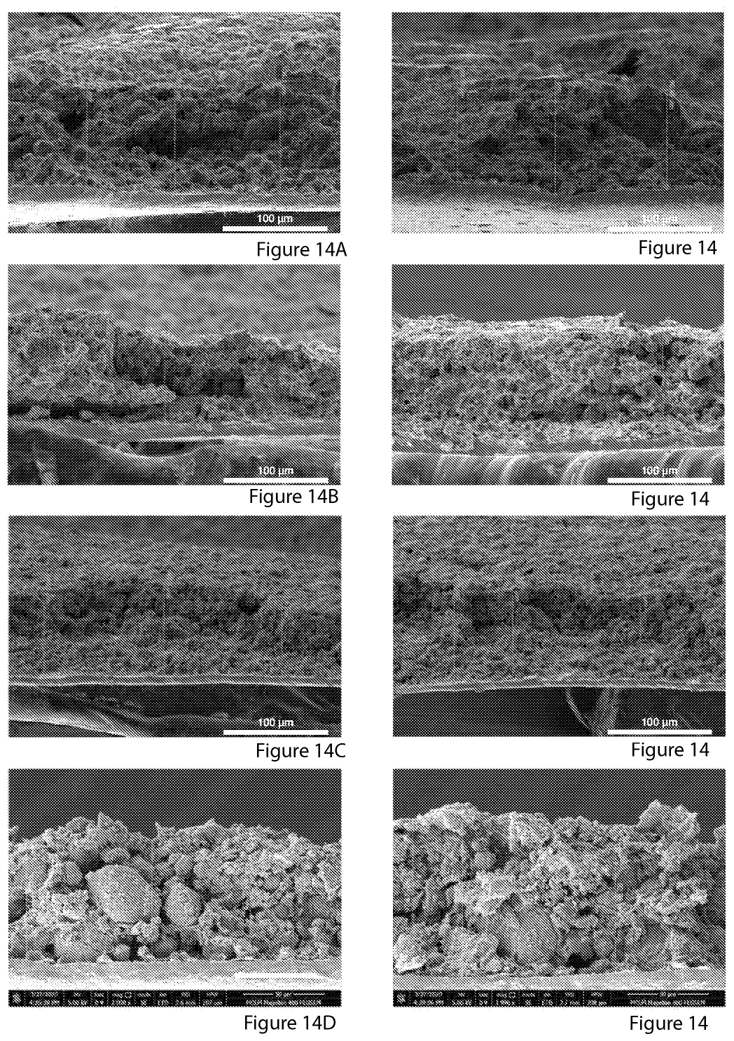

V (cathode) is the geometric volume of the electrode calculated using the thickness of the cathode as measured by cross-section SEM and depicted in FIG. 14. V_{dense}(cathode) is the dense volume of the cathode, calculated by the measured mass of the coating and dividing it by the apparent density of all the cathode components as determined by gas pycnometer. The results displayed in FIG. 9a, illustrate that the porosity of cathode increased with increasing content of glucose. The mechanical test result (FIG. 9b) showed that the hardness of CMC film was enhanced by employing glucose, the overall rupture point decreased, but importantly, the force required for small displacements (less than 250 μm) was increased by adding glucose. The combination of the elevated hardness and increased force requirement for small scale deformation of CMC/G composite, suggest a superior binder system for managing the ˜80% volume change of the sulfur electrodes.

To the best of our knowledge, a clear evaluation standard of rheological properties for electrode slurries has not been contemplated. Based on the viscoelastic filament study of the binder and the corresponding performance of batteries (FIG. 16) in this research, we propose using Ohnesorge (Oh) number³⁶ as a selection guide for binders to generate the web-like and well-segregated architecture. In below, we will discuss that the binder system with Oh number>1 and within double-digit is optimal for web-like network formation which helps to develop a segregated structure within the electrode.

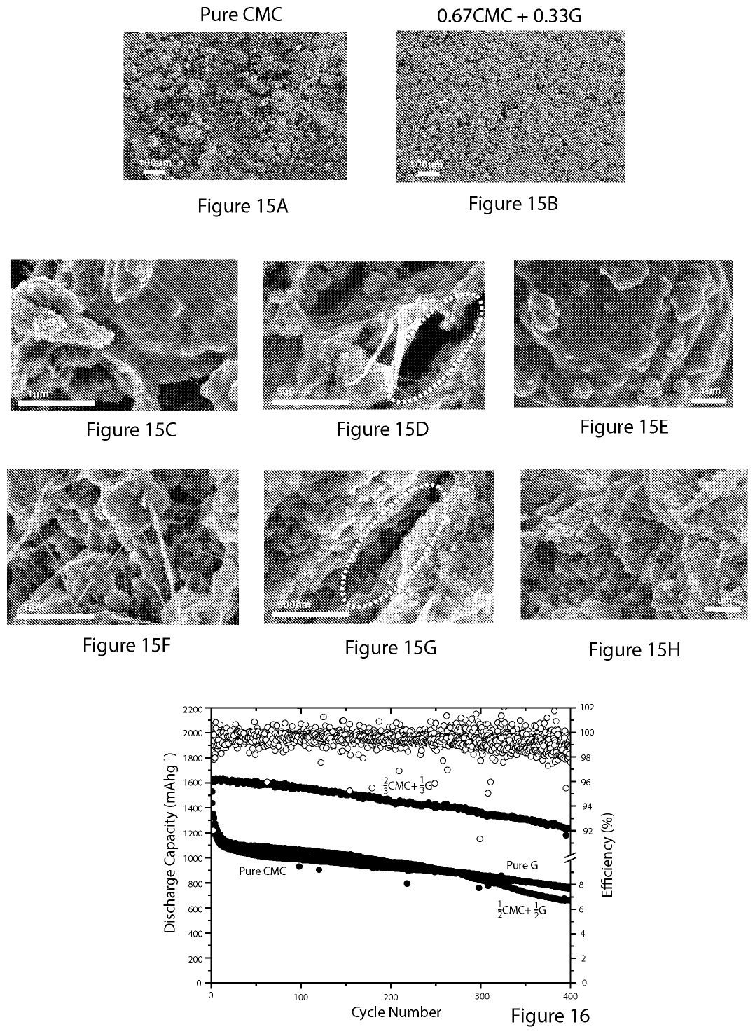

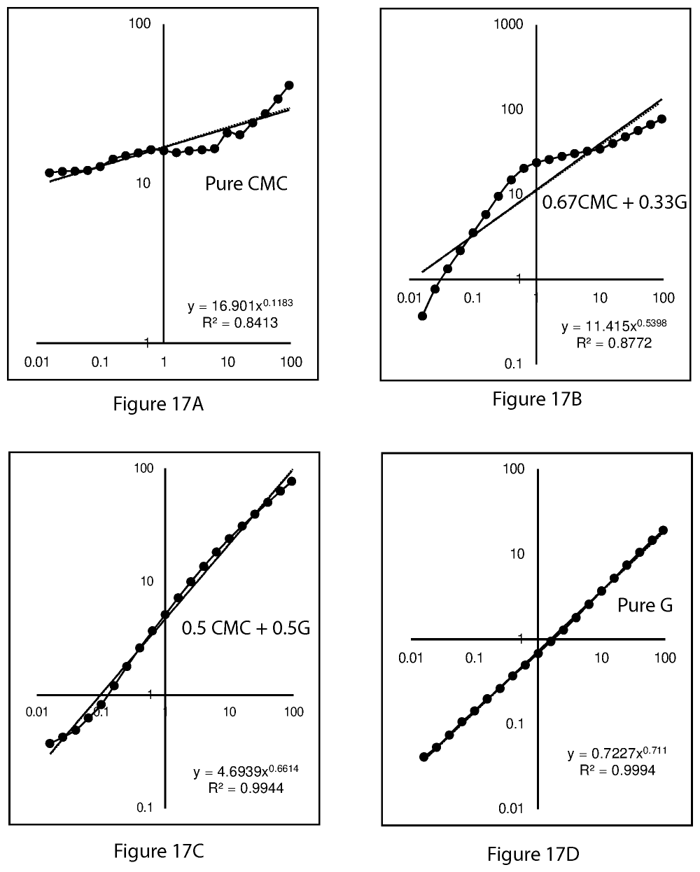

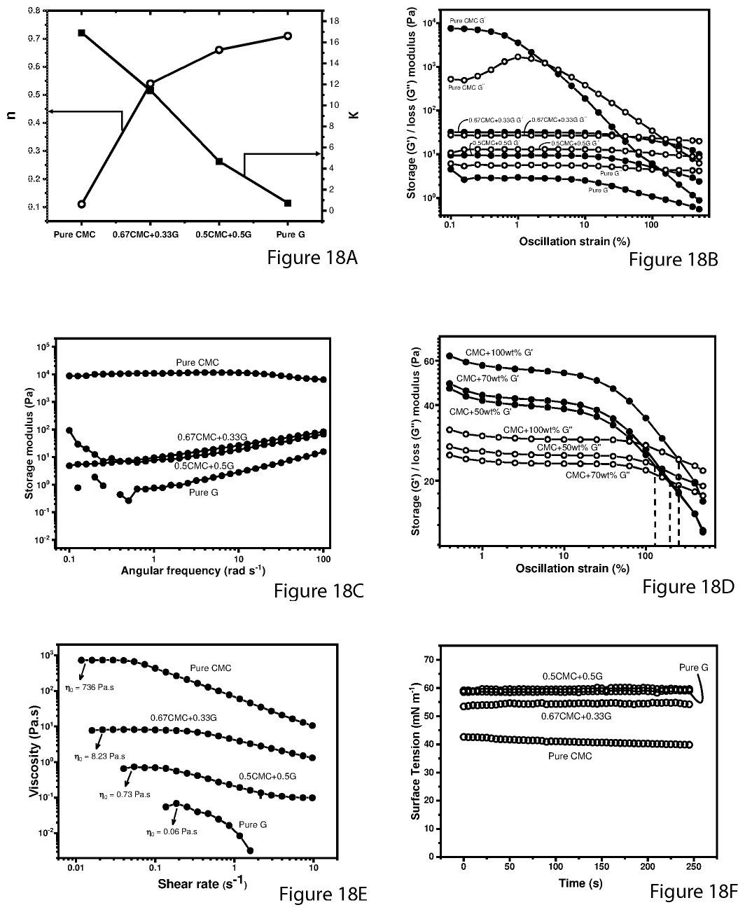

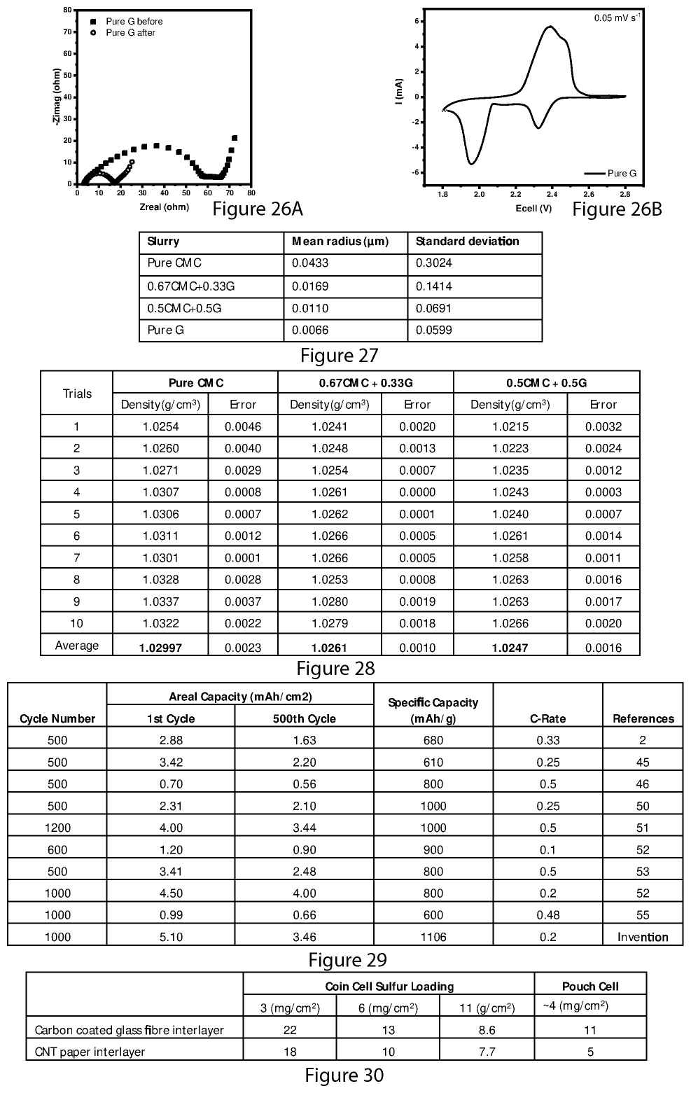

The physical properties of cathode slurries were evaluated using the rheological tests. The steady state shear rheology, depicted in FIG. 9c, shows that while the slurry with CMC and glucose as co-binder has lower apparent viscosity, it has a lower degree of shear thinning characteristics as evident from the fit of the power law model to the steady-state shear flow measurements (FIG. 17). The sudden change in the value of flow index (n) with the addition of glucose (pure CMC vs. ⅔ CMC+⅓ G) can be accounted for the reduction in the flow behaviour (FIG. 26a), from increased molecular interactions from the small glucose molecules with the polymeric chains of CMC. This means that under high shear stress, such slurries are less likely to deform³⁷.

Apart from flow properties, the dynamic behaviour of slurries plays a vital role in stability and mechanical properties of the binder and the binder-solid particle interaction. The principles of viscoelastic filament thinning, and breakup come into effect by the action of viscous drag and capillary forces. When the binder liquid is stretched during the process of mixing with solid particles, a string or filament of liquid forms between them. On solidification, the filament is consolidated if the filament can retain the stability before drying, and this phenomenon determines how the bridge-like network is formed. To rationalize the formation of the filamentous structures in the cathode, we used a dimensionless number, Ohnesorge number.

$$Oh = {η}_{0} / \sqrt{ρ R γ} \qquad Equation 2$$

This represents the relative importance of viscous with inertial and capillary forces³⁸. Here η₀ is zero-shear viscosity, ρ is density, γ is the surface tension of the liquid and R is the radius of the filament³⁹. The magnitude of Oh can designate three different morphologies of filamentous structures. For viscous filaments with Newtonian behaviour and Oh>1, the formation of beads-on-a-string (BOAS) morphology is predicted. In the case of non-Newtonian filaments, elasticity disrupts the formation of the beads giving axially uniform shape. For low viscosity filaments with Oh<1 inertially and capillary dominated slender thread type morphology forms which can become non-uniform with time³⁶.

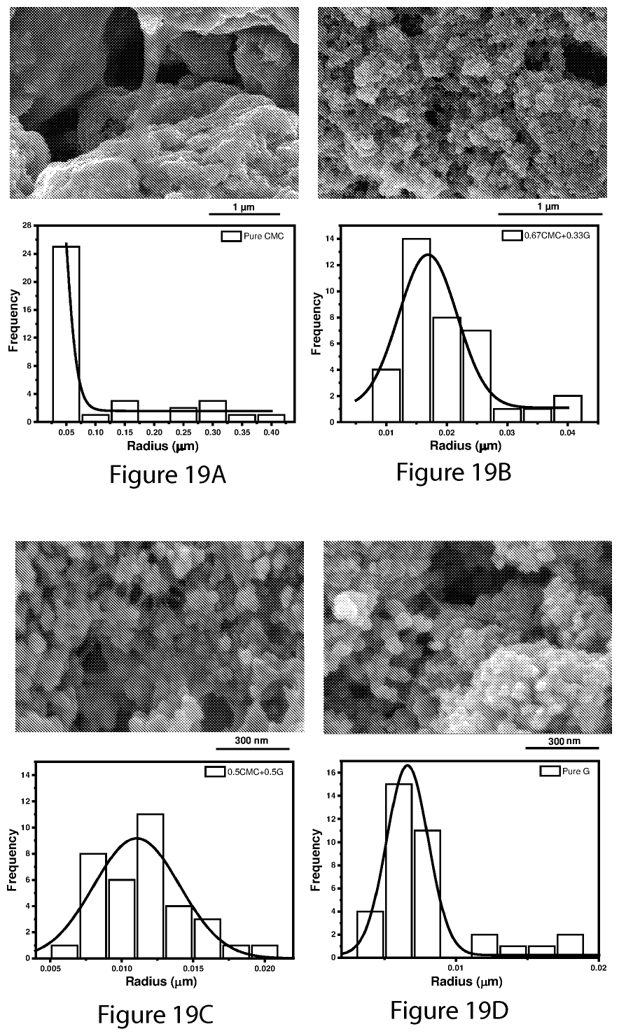

Using SEM micrographs, the average and mean radius of the filaments were deduced by plotting log-normal and gaussian distribution curves (FIG. 19 and FIG. 27) for a) Pure CMC, b)

$$\frac{2}{3} CMC + \frac{1}{3} G ,$$

c)

$$\frac{1}{2} CMC + \frac{1}{2} G$$

and d) Pure glucose as binder. The mean radius x_{c} and standard deviation w stand high at 0.04 microns and 0.30 respectively for pure CMC binders. With the addition of glucose, the mean, as well as standard deviation decreases indicating filament thinning behaviour.

TABLE 2
Ohnesorge number calculation

| Binder | | | | | |
|---|---|---|---|---|---|
| filaments | η0(Pa · s) | (kg/m3) | R(μm) | Y(mN/m) | Oh |
| Pure CMC | 736.00 | 1029.97 | 0.043 | 40.64 | 547.03 |
| $\frac{2}{3} CMC + \frac{1}{3} G$ | 8.23 | 1026.10 | 0.017 | 54.64 | 8.46 |
| $\frac{1}{2} CMC + \frac{1}{2} G$ | 0.73 | 1024.67 | 0.011 | 59.85 | 0.89 |
| Pure G | 0.06 | 1024.60 | 0.007 | 58.89 | 0.10 |

The estimated Ohnesorge number for the four binder systems (without sulfur and carbon) are tabulated in Table 2. It was found that for pure CMC and ⅔CMC+⅓G, Oh>1 while for ½CMC+½G and pure G, Oh<1. Pure CMC with Oh=547.03>>1 shows viscosity dominated filament formation. Our amplitude sweep measurements in FIG. 26b support the viscoelastic nature of pure CMC and ⅔CMC+⅓G binder systems. The extent of linear viscoelastic (LVE) regime suggests that pure CMC has a solid-like (elasticity-dominant) behaviour. With large viscous drag, viscosity-dependent elongation ensures the filaments are axially uniform with a large mean radius and high elasticity maintains the large radius after the elongation has ceased. In general, the addition of glucose to the CMC system decreases not only the viscosity (FIG. 9c), but also the elasticity. For example, the difference between storage modulus G′ and loss modulus G″ (FIG. 26b) for ⅔CMC+⅓G is smaller than pure CMC, indicating a decrease in elasticity-dominant behaviour. The decrease in elasticity can be further confirmed by frequency dependence of G′ in our frequency sweep measurements (FIG. 26c). The applied forces here are of capillary nature, which dominates over viscous drag (Oh ˜8) and elasticity leading to thinner and axially uniform filaments.

For ½CMC+½G and pure G, Ohnesorge number Oh<1, indicates the domination of inertiocapillary forces as demonstrated by low-viscosity fluid filaments leading to thinner filaments (mean radius x_{c}=0.011 microns and 0.007 microns for ½CMC+½G and pure G respectively)⁴⁰. Additionally, these slurries show liquid-like behaviour with G″ higher than G′ in the amplitude sweep measurement (FIG. 26b) and supported by frequency sweep measurements (FIG. 26c) indicating loss of elastic nature likely from broken down molecular network rendering a more liquid-like behaviour⁴¹. The addition of glucose to the polysaccharide binder decreases the viscosity and elasticity and promotes the web-structure of thin filaments between the particles by maintaining a balance between viscous and capillary forces which otherwise would form an agglomerated network of particles. FIG. 8 tabulates the densities measured of the four different binders.

To evaluate the adhesion and cohesion strength of electrodes, peeling test among four samples is performed⁴². Mounting tape is pressed intimately on the surface of the electrodes and removed with a steady motion. As shown in FIG. 9d, the force required to peel off the tape on electrode is decreasing with the increasing amount of glucose added to the binder system. In the meantime, more particles peel off from the electrode (FIG. 9e-h), which are associated with the reduced radius and weakened binder filaments (FIG. 9i-l ).

### Cycling Performance at Coin Cell and Pouch Level and Post-Mortem Study

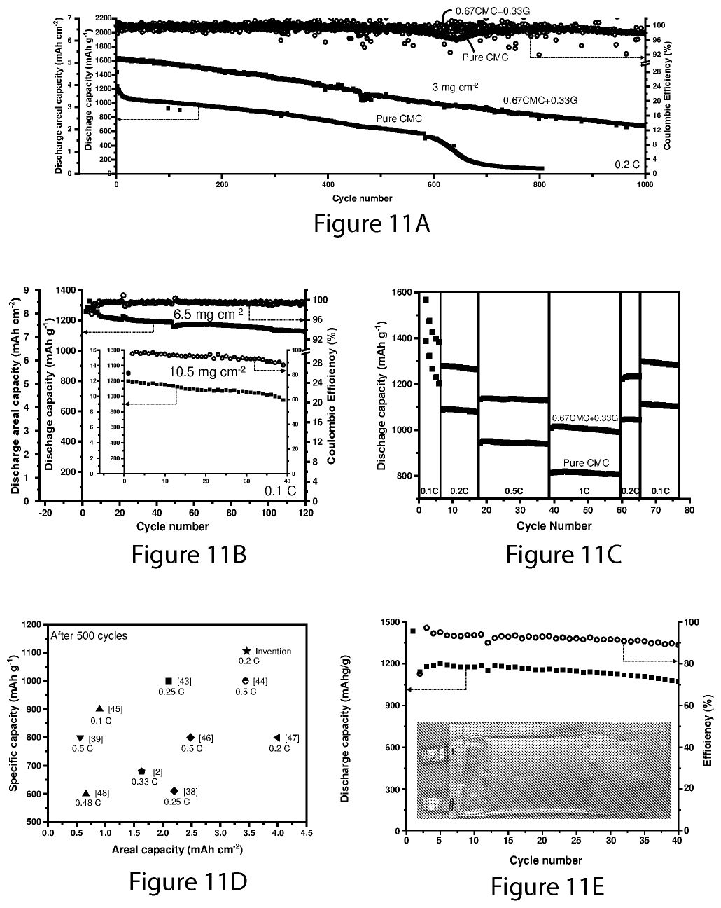

To verify the impact of glucose on cycling performance, we prepared cathodes with different compositions (Table 1) and sulfur loadings. For a cathode with CMC/G binder system (sample ⅔ CMC+⅓ G) and sulfur loading of 3 mg cm⁻², we achieve an exceptional 97% sulfur utilisation, delivering an initial capacity of 1629 mAhg⁻¹ with above 99% efficiency and an areal capacity of 5.1 mAh cm⁻² at 0.2 C (FIG. 11a). Importantly, this cathode demonstrates ultra-long cycle life while maintaining high reversible capacity, 1106 mAhg⁻¹ after 500 cycles and around 700 mAhg⁻¹ after 1000 cycles, over 9 months of continual operation. In contrast, the cathode with pure CMC binder shows 23% lower initial capacity and whilst delivering stable performance over the first few hundreds of cycles, demonstrates a dramatic capacity decay after around 580 cycles. The exceptional capacity retention performance of both cathodes over the first 500 cycles demonstrates the capability of the CMC as a binder which enables the fabrication of highly robust cathodes. However, it is only in the presence of glucose with its unique polysulfide regulation capability and web-like network formation that achieving 1000 high capacity cycles is possible. FIG. 29 provides a comparison of our cycle performance with previous studies

The CMC/G binder system can be used to successfully fabricate high sulfur loading electrodes (6.5 mg cm⁻²) which shows high specific capacity above 1200 mAhg⁻¹ with 120 stable cycle life. Even at ultrahigh loading (10.5 mg cm⁻²), the battery achieves 12.56 mAh cm⁻² areal capacity and high efficiency, >98%, depicted in FIG. 11b. Quite importantly, the CMC/G cathode delivered far better rate capability performance compared to that of CMC cathode, around 1000 mAh g⁻¹ at 1 C cycle rate (FIG. 11c). In addition, as shown in FIG. 11d, with the increase in sulfur loading, the specific capacity demonstrates a superior retention. For instance, at 5 mg cm⁻², the cathode delivers specific capacity of 1256 mAh g⁻¹ and, at 10.5 mg cm⁻², it still delivers a specific capacity as high as 1189 mAh g⁻¹. In FIG. 11e, we have drawn a performance comparison in the literature of high-cycle life Li—S cells, >500 stable cycles^{2,43-55}. As can be seen, our cathodes demonstrate superior performance in the combined metrics of areal capacity and cycle life. The pouch cell prototype with a capacity 1200 mAh g⁻¹ shown in FIG. 11f demonstrates the scalability of the cathode production. As shown in FIG. 6g, the pouch cell prototype with optimized configuration and lean electrolyte condition achieved energy density of up to 225 Wh kg⁻¹ while demonstrating great stability, indicates the potential for a successful translation from laboratory to industrial production.

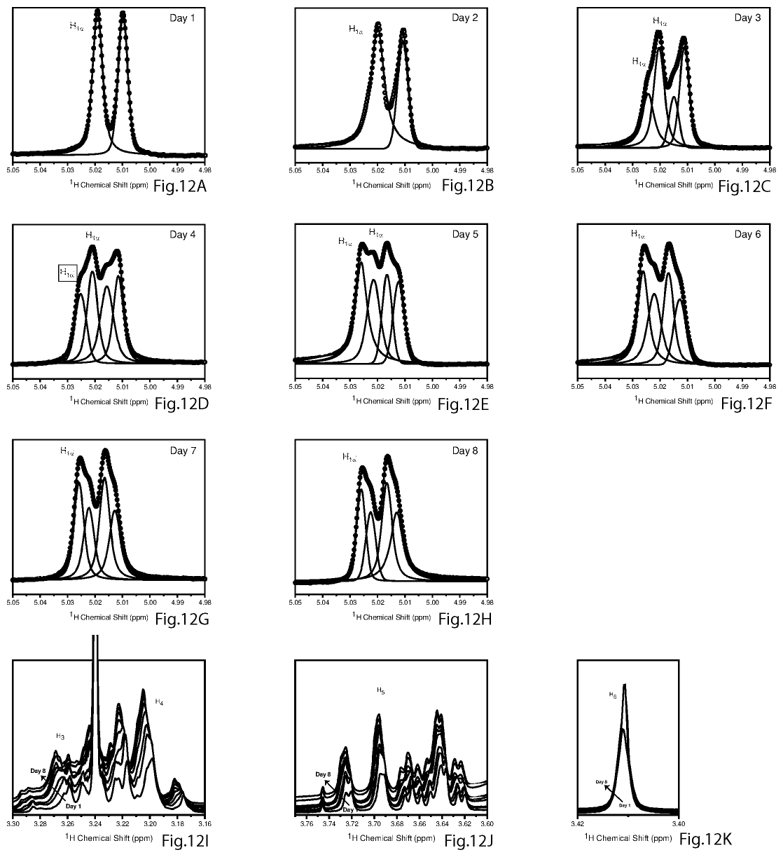

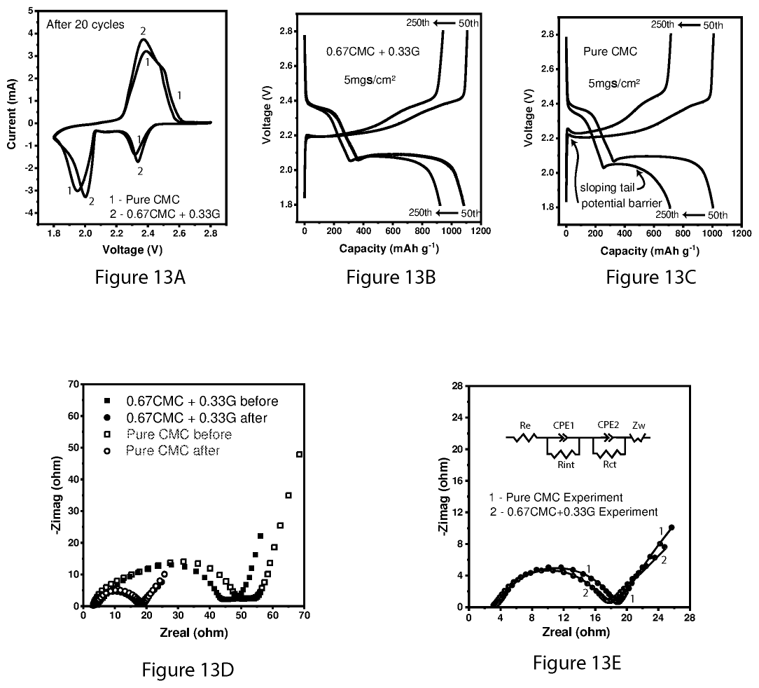

Electrochemical behaviour of identical cells configured with CMC/G and CMC cathodes is further studied by analysing their cyclic voltammogram (CV), charge/discharge profiles and electrochemical impedance spectroscopy (EIS) spectra. The CV profiles of both cells after 20 cycles exhibit two major reduction peaks around 2.3V and 2.0V, as depicted in FIG. 13a. Theoretically, the peak at higher cathodic voltage is related to the reduction of sulfur to high order LiPS (Li₂Sₙ, 4≤n<8), and the peak at the lower voltage is associated with the conversion of higher order LiPS to lower order LiPS (Li₂S₂ and Li₂S). The reactions are reversed in the anodic scan. CMC/G cathode displays higher magnitude of cathodic and anodic peaks, demonstrating enhanced lithiation/delithiation kinetics⁵⁶. Moreover, the CMC/G cathode exhibits the reduction peaks at a relatively higher voltage range compared to the CMC cathode, suggesting lower resistance of the electrochemical reaction⁵⁷. As shown in FIG. 13b to d, identical cells with CMC/G cathode and CMC cathode (6 mg cm⁻² sulfur loading) were made for lithium-ion diffusion coefficient test. A series of CVs with different scan rates were used for calculation according to the Randles-Sevick equation^{45,58}. The values of lithium-ion diffusion coefficient were evaluated to be 1.47×10⁻⁷ cm² s⁻¹ to 4.56×10⁻⁷ cm² s⁻¹ for lithium-sulfur batteries with CMC/G cathode, and 1.28×10⁻⁷ cm² s⁻¹ to 3.57×10⁻⁷ cm² s⁻¹ for CMC cathode. The elevated lithium-ion diffusion coefficient for CMC/G cathode confirms the enhanced lithiation/delithiation kinetics of sulfur cathode using CMC+G binder system.

The 50^{th}and 250^{th} charge/discharge profiles of the two cells with 5 mg cm⁻² sulfur loading are plotted in FIG. 13e and f. In the charge profiles of the cell with CMC cathode, distinct potential barrier occurred at the beginning of the charging process, demonstrating the presence of insulating Li₂S₂and Li₂S deposited on the electrode surface and greater polarization⁵⁶. Furthermore, the 250^{th} discharge plot of the cell with CMC cathode shows a sloping tail which is associated with the solid to solid reduction of Li₂S₂ to Li₂S⁵⁶. When the Li₂S₂ formation dominates the final step of the reduction to Li₂S, rather than Li₂Sₙ (4≤n<8), the dynamics of the electrochemical conversion are more sluggish due to the retarded diffusion kinetics in solid-state. This phenomenon is relieved to a large extent in the cell with CMC/G cathode. The possible explanation is that the web-like structure and increased porosity of the CMC/G electrode provides mass transfer highways for electrolytic species.

Electrochemical impedance spectroscopy (EIS) is carried out to verify the alternating current (AC) impedance of the two cells before and after 80 cycles (FIG. 13g and h) by fitting the Nyquist plots with the equivalent circuits^{59,60}. The equivalent circuit features electrolyte resistance, two RC (resistance and constant phase element) parallel elements in series representative of the resistance of the solid electrolyte interphase and charge-transfer, and the Warburg diffusion impedance corresponding to the diffusion of Li-ion on the interfaces between electrolyte and electrodes⁵⁹. It shows that the CMC/G cathode yields lower charge-transfer resistance which is consistent with the reduced internal resistance and enhanced ionic transfer in the web-like network of the cathode architecture.

Finally, further evidence of the superior LiPS regulation ability of glucose is observed by the post-mortem SEM of the cycled lithium anodes and sulfur cathode. After an intense 100 cycles of rate capability test from 0.1 C to 1 C, cells were disassembled and lithium metal anodes and sulfur cathode were washed by DOL/DME and collected for SEM imaging. As shown in FIG. 15a, the surface of the lithium metal from the cell with CMC cathode is severely corroded. On the other hand, for the lithium anode coupled with CMC/G cathode (FIG. 15b), the corrosion is considerably reduced, and more uniform surface topography is noticeable. The SEM images and EDS mappings of the full charge/delithiation state of both CMC and CMC/G cathode are presented in FIG. 15c-h. The lower magnification images shown in FIG. 15c and f show no obvious microstructural changes for both the cling wrap-like binder film in CMC cathode and the web-like binder structure in CMC/G cathode. The EDS mappings (FIG. 15e and h) confirm structural integrity of both binders after cycling. Nevertheless, more structural details are provided by higher magnification images. CMC cathode (FIG. 15d) demonstrates the evolution of large crack as cause of delamination between binder film covered surface layer and the layer underneath, which is a clear structural disintegration after exposure to intense cycling stress. In contrast, the CMC/G cathode (FIG. 15g) demonstrates preserved binders between particles. Benefited from the segregated microstructure for accommodating the volume changes during cycling, CMC/G cathode develops no major cracks after cycling.

### Further Test Results

FIG. 12 shows an in depth ¹H NMR analysis of the glucose-Li₂S₆ interaction within a simulated battery environment.

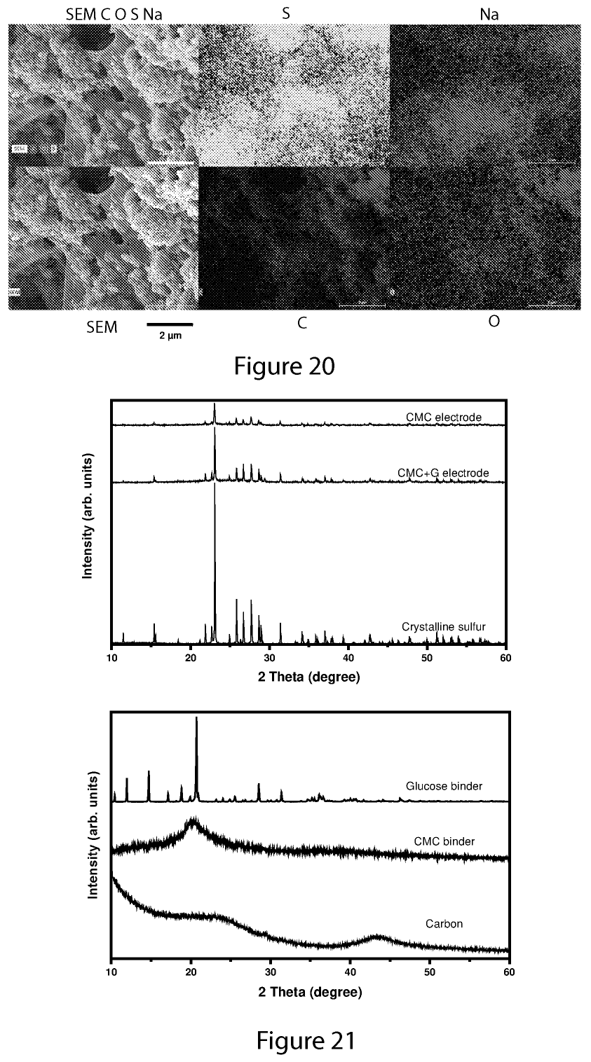

FIG. 20 shows EDX mapping of sulfur cathode with

$$\frac{2}{3} CMC + \frac{1}{3} G$$

as binder.

FIG. 21 shows XRD of electrode and associated components.

FIG. 23 shows discharge capacities (0.2 C) of coin cell configured with a) 1 mg cm⁻² and b) 0.5 mg cm⁻² carbon coated glass fibre interlayer, based on the mass of sulfur (red lines), total mass of the electrode (light-orange line), and total mass of the electrode and additional interlayers (dark-yellow line) on the cathode side of the cell. Proportion of each component in cathodic system configured with c) 1 mg cm⁻² and d) 0.5 mg cm⁻² carbon coated glass fibre interlayer.

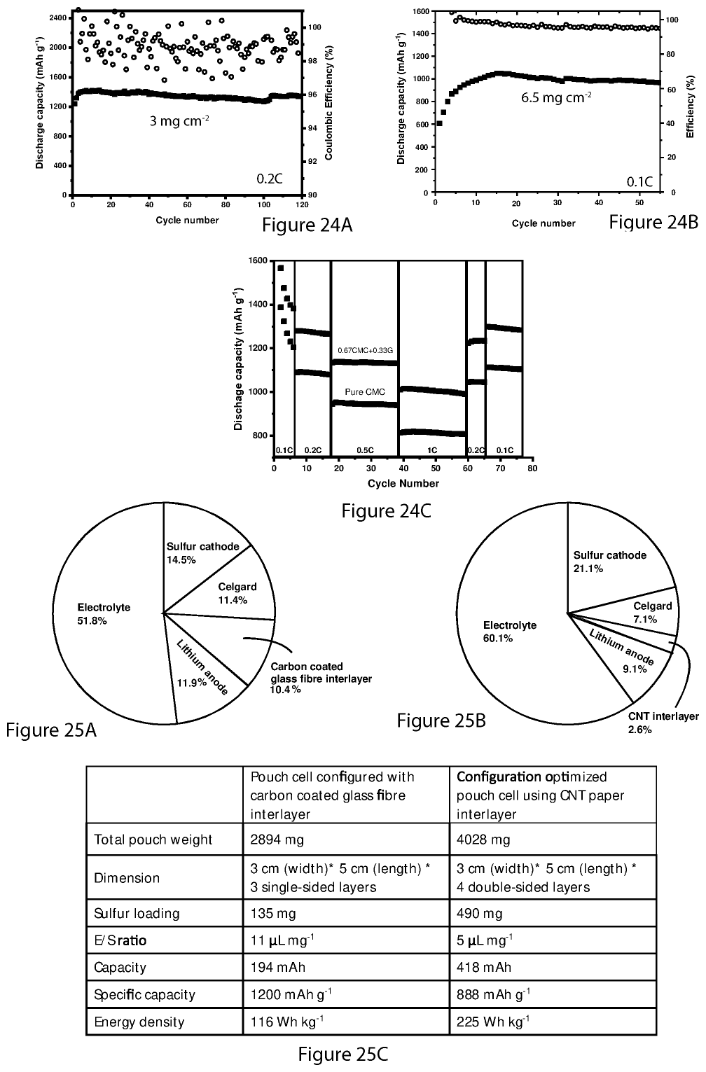

FIG. 24 demonstrates Applications of CNT interlayer. Identical cells were made while replacing the carbon coated glass fibre interlayer which unduly absorbs a lot of electrolyte with an ultralight CNT (carbon nanotube) paper interlayer (0.5 mg cm−2), which advantageously acts as an upper current collector that allows for lean electrolyte conditions. In the newly made cells, the electrolyte to sulfur ratio was reduced to around 7.7-18 μL mg−1 at the coin cell level. Cycling performance of the CMC/G cathode with the ultralight CNT interlayer for coin cells with a) 3 mg cm⁻² sulfur loading b) 6.5 mg cm⁻² sulfur loading. c) Rate capability data among two compared samples (3 mg cm⁻² sulfur loading for cathode) configured with CNT interlayer, red lines indicate the performance of CMC/G cathode, and the brown lines indicate the performance of CMC cathode.

FIG. 25 compares two different pouch cells, with the proportion of each component of a) Pouch cell configured with single-sided cathode and carbon coated glass fibre interlayer, and b) Optimized pouch cell with double-sided cathodes and CNT paper as the interlayer. c) Detailed information of these two pouch cells.

FIG. 26 shows electrochemical characterisation on pure glucose cathodes, with a) Nyquist plots; b) Cyclic voltammogram profiles.

### Methodology Used to Develop the Invention

For fabrication of the sulfur cathodes the first step of slurry preparation was dry mixing of all ingredients by a magnetic stirring bar in the following order. Sulfur and conductive carbon powder were mixed for 24 hours, followed by adding different kinds of binder powder to the mixture and continuing the dry mixing of all three ingredients for another 24 hours. Then, 3 mL/g of deionised (DI) water was added to the well-mixed ingredients. All ingredients were mixed in water with a magnetic stirring bar for 12 hours to make a homogenous slurry. For comparison and proportional optimisation among cathodes with various binder composite, there are four cases of cathodes explained in Table 1. The sulfur loading for the cathode was from 2 mg cm⁻² to 11 mg cm⁻².

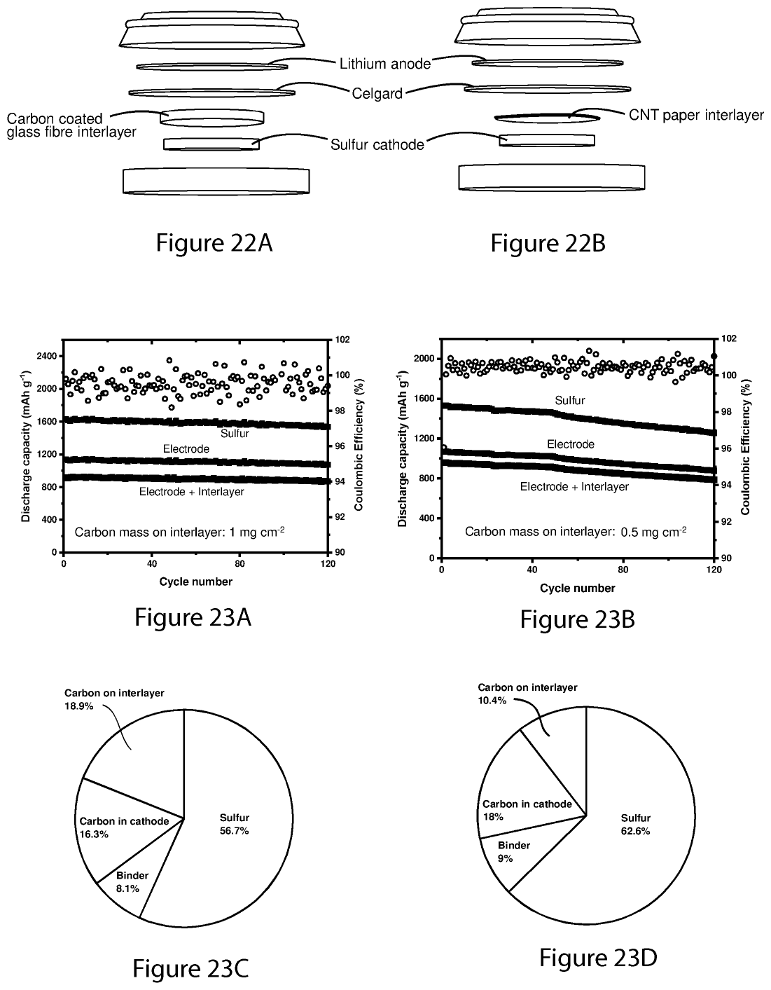

For cell fabrication and electrochemical tests the glass fibre interlayer was coated with an aqueous slurry mixture of 80 wt. % carbon and 20 wt. % Gum Arabic, acting as an upper current collector. The mass of carbon content on the interlayer was 1 mg cm⁻² at a sulfur loading of 3 mg cm⁻², 1.5 mg cm⁻² for a sulfur loading of 6 mg cm⁻², and 2 mg cm⁻² for a sulfur loading of 11 mg cm⁻². Therefore, the total sulfur content including interlayer was 56.7%-62.1%. A Celgard separator was used as the separator. A schematic diagram of cell configuration is shown in FIG. 22.

The electrolyte was prepared by dissolving 1 M Bis (trifluoromethane) sulphonamide lithium (LiTFSI) and 0.5 M lithium nitrate (LiNO₃) in 1,3-dioxolane (DOL) and 1,2-dimethoxyethane (DME) (1:1, v/v). The electrolyte to sulfur ratio was in the range of 8.6-22 μL mg⁻¹, depending on the S loading. For example, for the cathode at 3 mg cm⁻², 15 μL of electrolyte was used to wet the cathode. To wet the carbon coated glass fibre and Celgard separator, 50 μL of electrolyte was used. For the cathode with 6 mg cm⁻². 20 μL of electrolyte was used to wet the cathode. To wet the carbon coated glass fibre and Celgard separator, 60 μL of electrolyte was used. For the cathode with 11 mg cm², 25 μL of electrolyte was used to wet the cathode. To wet the carbon coated glass fibre and Celgard separator, 70 μL of electrolyte was used. Typically, increased amount of electrolyte was used for increased sulfur loading of the cathode. A summary of E/S ratio is shown in FIG. 30. For coin cell assembly, all the steps were conducted in argon glovebox and electrochemical testing was done by EC-lab (Bio-logic).

The synthesis of Li₂S₆ solution was followed from the method reported by Kaiming et al.⁶¹. Elemental sulfur and Li₂S powder were mixed in a solvent of DOL and DME solvent (DOL/DME=50/50 (v/v)) at 50° C. for 36 h under stirring in an Argon glove box and with a molar ratio of 8:5 (8Li₂S+5S₈→8Li₂S₆). The resultant was centrifuged at 5000 rpm for 10 min to abandon the particles inside, and the remaining red-brown solution is the Li₂S₆ solution.

For scanning electron microscopy imaging and EDX mapping the sample was mounted on A1 stub with conductive carbon tap and coated with iridium for the front section and cross-section imaging. Nova 450 FESEM and Magellan 400 FESEM were used for secondary electron imaging and energy dispersive spectroscopy mapping (EDX).

The mechanical Tensile and indentation tests were carried on two iridescent films. The Instron 5965 with 5 kN load capacity was utilised for the tensile test. Wedge grips were applied to hold the specimens; rubber inserts were placed inside the grips to prevent tearing of films. The CMC and CMC with glucose films were cut into 5 cm long strips with a width equal to 2 cm rectangular shape with the same thickness (24 μm). The initial gage length was set at 3 cm. Tests were done under displacement control, dry conditions. Strain rates were 1 mm/min. The hardness data was obtained by Duramin A-300 Micro-Hardness tester, 0.1N load was applied with 10 s loading time. Each sample was repeated the indentation step ten times and got the average value.

A gas pycnometer (Micromerities; AccuPyC II 1340) was used to measure the density of cathode ingredients mixture and binder liquid.

Rheological tests were done using a strain-controlled ARES G2 rheometer (TA instruments, USA) using a cone and plate geometry (dia-50 mm, cone angle−2°). A constant gap of 0.045 mm and temperature of 23.00±0.01° C. was maintained during the measurements. For steady-state measurements, viscosity change as a function of shear rate ranging from 0.1 to 100 s⁻¹ was recorded. The amplitude sweep was done at an angular frequency of 10 rad/s, in a range from 0.1% to 100% strain amplitude, to determine the linear viscoelastic (LVE) regime. Frequency sweep was done over the range of 0.1 to 100 rad/s.

The measurement of surface tension of cathode slurries was carried out using a customised pendant drop setup running OpenDrop software version 1.2. For measurement, a stable droplet of the slurry was created through a 2.7 mm outer diameter stainless steel blunt-tipped needle. The software recorded the value of surface tension every 5 seconds for a period of 250 seconds.

Raman spectra were obtained using a Renishaw inVia Raman Spectrometer equipped with 632.8 nm HeNe laser excitation operating at 10% power with a laser spot size of 1 μm and an accumulation time of 30 s. Extended scans were performed and spectra were recorded over 180 to 600 cm⁻¹ range. A 100 μm slit was employed.

In order to examine the functional groups from the solid residues, Fourier Transform Infrared Spectroscopy (FTIR) spectra were recorded using an attenuated total reflectance FTIR spectrometer (PerkinElmer, USA) in the range of 400-4000 cm⁻¹ at an average of 32 scans.

For the UV-visible spectroscopy the concentration of lithium sulfide (Li₂S₆) applied in the UV-vis test is 6 mmol/L, in DOL/DME (1:1 v/v). 50 mg of polymer binder was soaked in 6 ml lithium polysulfide in DOL/DME electrolyte in a UV quartz container. The spectra were collected through the Thermo Scientific Evolution 220 UV-Visible Spectrophotometer during the 24-hour period.

All density functional theory (DFT) calculations were carried out using the Vienna Ab Initio Simulation Package (VASP)^{62,63}. The projector augmented wave (PAW)⁶⁴ pseudopotentials are utilized to describe core and valence electrons, and the generalized gradient approximation based on the Perdew-Burke-Ernzerhof (GGA-PBE)⁶⁵ function is used to describe electron exchange and correlation. Dipole correction is also considered here to avoid any spurious interactions between molecules. We select the plane-wave based kinetic energy cutoff of 450 eV, and the Γ-centered 1×1×1 Monkhorst-Pack⁶⁶ k-point mesh for sampling the Brillouin zones of polysulfide and organic molecules without and with site adsorption. The simulation boxes of 30 Å×30 Å×30 Å and 10 Å×45 Å×45 Å are set for glucose molecules without and with adsorbed polysulfide molecules.

NMR experiments were performed on Bruker Avance 400 MHz NMR spectrometers. NMR experiments were performed with the sample held at 25±0.1° C. for routine analysis. Chemical shifts for all experiments are referenced using the Unified Scale relative to 0.3% tetramethylsilane in deuteriochloform^{67,68.} Samples for NMR spectroscopy were prepared by dissolving the analyte in deuterated solvent, as specified, and placing the solution into a 5 mm NMR tube. The data were processed using Bruker TopSpin v3.6.2 software.

The reader will now appreciate the present invention which provides a saccharide based binder system with improved polysulfide regulation ability porosity resulting in outstanding cycling ability

Further advantages and improvements may very well be made to the present invention without deviating from its scope. Although the invention has been shown and described in what is conceived to be the most practical and preferred embodiment, it is recognized that departures may be made therefrom within the scope of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

In the present specification and claims (if any). the word “comprising” and its derivatives including “comprises” and “comprise” include each of the stated integers but does not exclude the inclusion of one or more further integers.

### REFERENCES

1 Dörfler, S. et al. Recent Progress and Emerging Application Areas for Lithium-Sulfur Battery Technology. Energy Technology 9, 2000694 (2021).
2 Qie, L., Zu, C. & Manthiram, A. A high energy lithium-sulfur battery with ultrahigh-loading lithium polysulfide cathode and its failure mechanism. Advanced Energy Materials 6, 1502459 (2016).
3 Lin, D., Liu, Y. & Cui, Y. Reviving the lithium metal anode for high-energy batteries. Nature nanotechnology 12, 194 (2017).
4 Kolosnitsyn, V. & Karaseva, E. Lithium-sulfur batteries: Problems and solutions. Russian Journal of Electrochemistry 44, 506-509 (2008).
5 Barchasz, C. et al. Lithium/sulfur cell discharge mechanism: an original approach for intermediate species identification. Analytical chemistry 84, 3973-3980 (2012).
6 Lv, D. et al. High energy density lithium-sulfur batteries: challenges of thick sulfur cathodes. Advanced Energy Materials 5, 1402290 (2015).
7 Ji, X. & Nazar, L. F. Advances in Li—S batteries. Journal of Materials Chemistry 20, 9821-9826 (2010).
8 Evers, S., Yim, T. & Nazar, L. F. Understanding the nature of absorption/adsorption in nanoporous polysulfide sorbents for the Li—S battery. The Journal of Physical Chemistry C 116, 19653-19658 (2012).
9 Shaibani, M. et al. Expansion-tolerant architectures for stable cycling of ultrahigh-loading sulfur cathodes in lithium-sulfur batteries. Science advances 6, eaay2757 (2020).
10 Deng, Z. et al. Electrochemical impedance spectroscopy study of a lithium/sulfur battery: modeling and analysis of capacity fading. Journal of the Electrochemical Society 160, A553 (2013).
11 Li, G. et al. Acacia senegal-inspired bifunctional binder for longevity of lithium-sulfur batteries. Advanced Energy Materials 5 (2015).
12 Liu, J. et al. Exploiting a robust biopolymer network binder for an ultrahigh-areal-capacity Li—S battery. Energy & Environmental Science 10, 750-755 (2017).
13 Rao, M., Song, X., Liao, H. & Cairns, E. J. Carbon nanofiber-sulfur composite cathode materials with different binders for secondary Li/S cells. Electrochimica Acta 65, 228-233 (2012).
14 Pang, Q., Liang, X., Kwok, C. Y., Kulisch, J. & Nazar, L. F. A Comprehensive Approach toward Stable Lithium-Sulfur Batteries with High Volumetric Energy Density. Advanced Energy Materials 7 (2017).
15 Bao, W., Zhang, Z., Gan, Y., Wang, X. & Lia, J. Enhanced cyclability of sulfur cathodes in lithium-sulfur batteries with Na-alginate as a binder. Journal of Energy Chemistry 22, 790-794, doi:10.1016/S2095-4956(13)60105-9 (2013).
16 Milroy, C. & Manthiram, A. An elastic, conductive, electroactive nanocomposite binder for flexible sulfur cathodes in lithium-sulfur batteries. Advanced Materials 28, 9744-9751 (2016).
17 Wang, J., Yao, Z., Monroe, C. W., Yang, J. & Nuli, Y. Carbonyl-β-Cyclodextrin as a Novel Binder for Sulfur Composite Cathodes in Rechargeable Lithium Batteries. Advanced Functional Materials 23, 1194-1201 (2013).
18 Moers, M., De Leeuw, J., Cox, H. & Schenck, P. Interaction of glucose and cellulose with hydrogen sulphide and polysulphides. Organic geochemistry 13, 1087-1091 (1988).
19 Li, J., Lewis, R. & Dahn, J. Sodium carboxymethyl cellulose: a potential binder for Si negative electrodes for Li-ion batteries. Electrochemical and Solid State Letters 10, A17 (2006).
20 Lacey, M. J., Jeschull, F., Edström, K. & Brandell, D. Porosity blocking in highly porous carbon black by PVDF binder and its implications for the Li—S system. The Journal of Physical Chemistry C 118, 25890-25898 (2014).
21 Yuan, Z. et al. Powering lithium-sulfur battery performance by propelling polysulfide redox at sulfiphilic hosts. Nano letters 16, 519-527 (2016).
22 Zhou, G. et al. An aqueous inorganic polymer binder for high performance lithium-sulfur batteries with flame-retardant properties. ACS central science 4, 260-267 (2018).
23 Ling, M. et al. Nucleophilic substitution between polysulfides and binders unexpectedly stabilizing lithium sulfur battery. Nano Energy 38, 82-90 (2017).
24 Yeon, J. -T. et al. Raman spectroscopic and X-ray diffraction studies of sulfur composite electrodes during discharge and charge. Journal of The Electrochemical Society 159, A1308 (2012).
25 Zhu, X. et al. In Situ Assembly of 2D Conductive Vanadium Disulfide with Graphene as a High-Sulfur-Loading Host for Lithium-Sulfur Batteries. Advanced Energy Materials 8, 1800201 (2018).
26 Wu, H. -L., Huff, L. A. & Gewirth, A. A. In situ Raman spectroscopy of sulfur speciation in lithium-sulfur batteries. ACS applied materials & interfaces 7, 1709-1719 (2015).
27 Hagen, M. et al. In-situ Raman investigation of polysulfide formation in Li—S cells. Journal of The Electrochemical Society 160, A1205 (2013).
28 McBrayer, J. D., Beechem, T. E., Perdue, B. R., Apblett, C. A. & Garzon, F. H. Polysulfide speciation in the bulk electrolyte of a lithium sulfur battery. Journal of The Electrochemical Society 165, A876 (2018).
29 Toghill, K. E. & Compton, R. G. Electrochemical non-enzymatic glucose sensors: a perspective and an evaluation. Int. J. Electrochem. Sci 5, 1246-1301 (2010).
30 Liang, X. et al. A highly efficient polysulfide mediator for lithium-sulfur batteries. Nature communications 6, 1-8 (2015).
31 Dillard, C., Singh, A. & Kalra, V. Polysulfide speciation and electrolyte interactions in lithium-sulfur batteries with in situ infrared spectroelectrochemistry. The Journal of Physical Chemistry C 122, 18195-18203 (2018).
32 Zhang, L. et al. In situ optical spectroscopy characterization for optimal design of lithium-sulfur batteries. Chemical Society Reviews 48, 5432-5453 (2019).
33 Saqib, N., Silva, C. J., Maupin, C. M. & Porter, J. M. A novel optical diagnostic for in situ measurements of lithium Polysulfides in battery electrolytes. Applied Spectroscopy 71, 1593-1599 (2017).
34 Shi, Y., Zhou, X. & Yu, G. Material and structural design of novel binder systems for high-energy, high-power lithium-ion batteries. Accounts of chemical research 50, 2642-2652 (2017).
35 Kang, N. et al. Cathode porosity is a missing key parameter to optimize lithium-sulfur battery energy density. Nature communications 10, 1-10 (2019).
36 Bhat, P. P. et al. Formation of beads-on-a-string structures during break-up of viscoelastic filaments. Nature Physics 6, 625-631 (2010).
37 Kumar, P., Maiti, U. N., Lee, K. E. & Kim, S. O. Rheological properties of graphene oxide liquid crystal. Carbon 80, 453-461 (2014).
38 Li, D. Ohnesorge number. Encyclopedia of Microfluidics and Nanofluidics 1513 (2008).
39 Tirtaatmadja, V., Mckinley, G. H. & Cooper-White, J. J. Drop formation and breakup of low viscosity elastic fluids: Effects of molecular weight and concentration. Physics of fluids 18, 043101 (2006).
40 Ardekani, A., Sharma, V. & Mckinley, G. Dynamics of bead formation, filament thinning and breakup in weakly viscoelastic jets. (2010).
41 Liu, Y., Liu, L., Wang, Y., Zhu, G. & Tan, W. The rheological behavior of graphite oxide/cationic polyacrylamide suspensions. RSC advances 6, 102938-102946 (2016).
42 Gaikwad, A. M. & Arias, A. C. Understanding the effects of electrode formulation on the mechanical strength of composite electrodes for flexible batteries. ACS Applied Materials & Interfaces 9, 6390-6400 (2017).
43 Qiu, Y. et al. High-rate, ultralong cycle-life lithium/sulfur batteries enabled by nitrogen-doped graphene. Nano letters 14, 4821-4827 (2014).
44 Qie, L. & Manthiram, A. A facile layer-by-layer approach for high-areal-capacity sulfur cathodes. Advanced Materials 27, 1694-1700 (2015).
45 Yu, M. et al. Freestanding and Sandwich-Structured Electrode Material with High Areal Mass Loading for Long-Life Lithium-Sulfur Batteries. Advanced Energy Materials 7, 1602347 (2017).
46 Bai, S., Liu, X., Zhu, K., Wu, S. & Zhou, H. Metal-organic framework-based separator for lithium-sulfur batteries. Nature Energy 1, 1-6 (2016).
47 Pang, Q., Liang, X., Kwok, C. Y., Kulisch, J. & Nazar, L. F. A comprehensive approach toward stable lithium-sulfur batteries with high volumetric energy density. Advanced Energy Materials 7, 1601630 (2017).
48 Wang, M. et al. A multi-core-shell structured composite cathode material with a conductive polymer network for Li—S batteries. Chemical Communications 49, 10263-10265 (2013).
49 Xu, Z.-L. et al. Visualization of regulated nucleation and growth of lithium sulfides for high energy lithium sulfur batteries. Energy & Environmental Science 12, 3144-3155 (2019).
50 Hu, C. et al. In situ wrapping of the cathode material in lithium-sulfur batteries. Nature communications 8, 1-9 (2017).
51 Cha, E. et al. 2D MoS 2 as an efficient protective layer for lithium metal anodes in high-performance Li—S batteries. Nature nanotechnology 13, 337 (2018).
52 Wang, M. et al. Steam-etched spherical carbon/sulfur composite with high sulfur capacity and long cycle life for Li/S battery application. ACS applied materials & interfaces 7, 3590-3599 (2015).
53 Pang, Q. et al. A nitrogen and sulfur dual-doped carbon derived from Polyrhodanine@ Cellulose for advanced lithium-sulfur batteries. Advanced materials 27, 6021-6028 (2015).
54 Wang, X. et al. A robust sulfur host with dual lithium polysulfide immobilization mechanism for long cycle life and high capacity Li—S batteries. Energy Storage Materials 16, 344-353 (2019).
55 Zheng, M. et al. Activated graphene with tailored pore structure parameters for long cycle-life lithium-sulfur batteries. Nano Research 10, 4305-4317 (2017).
56 Cho, C. -S., Chang, J. -Y. & Li, C. -C. Highly symmetric gigaporous carbon microsphere as conductive host for sulfur to achieve high areal capacity for lithium-sulfur batteries. Journal of Power Sources 451, 227818 (2020).
57 Kim, M. S. et al. Langmuir-Blodgett artificial solid-electrolyte interphases for practical lithium metal batteries. Nature Energy 3, 889-898 (2018).
58 Huang, J. -Q. et al. Permselective graphene oxide membrane for highly stable and anti-self-discharge lithium-sulfur batteries. ACS nano 9, 3002-3011 (2015).
59 Liu, P. & Wu, H. Construction and destruction of passivating layer on LixC6 in organic electrolytes: an impedance study. Journal of power sources 56, 81-85 (1995).
60 Park, S. -H. et al. High areal capacity battery electrodes enabled by segregated nanotube networks. Nature Energy 4, 560-567 (2019).
61 Liao, K. et al. Stabilization of polysulfides via lithium bonds for Li—S batteries. Journal of Materials Chemistry A 4, 5406-5409 (2016).
62 Kresse, G. & Furthmüller, J. Efficiency of ab-initio total energy calculations for metals and semiconductors using a plane-wave basis set. Computational materials science 6, 15-50 (1996).
63 Kresse, G. & Furthmüller, J. Efficient iterative schemes for ab initio total-energy calculations using a plane-wave basis set. Physical review B 54, 11169 (1996).
64 Kresse, G. & Joubert, D. From ultrasoft pseudopotentials to the projector augmented-wave method. Physical review b 59, 1758 (1999).
65 Perdew, J. P., Burke, K. & Ernzerhof, M. Generalized gradient approximation made simple. Physical review letters 77, 3865 (1996).
66 Monkhorst, H. J. & Pack, J. D. Special points for Brillouin-zone integrations. Physical review B 13, 5188 (1976).
67 Harris, R. K. et al. Further conventions for NMR shielding and chemical shifts (IUPAC Recommendations 2008). eMagRes (2007).
68 Harris, R. K., Becker, E. D., De Menezes, S. M. C., Goodfellow, R. & Granger, P. NMR nomenclature. Nuclear spin properties and conventions for chemical shifts (IUPAC Recommendations 2001). Pure and applied chemistry 73, 1795-1818 (2001).

1. A binder for a cathode of a Lithium-Sulfur battery, the binder comprising a polysaccharide in combination with a monosaccharide.

2. The binder for the cathode of the Lithium-Sulfur battery as in claim 1, wherein the monosaccharide is glucose.

3. The binder for the cathode of the Lithium-Sulfur battery as in claim 2, wherein the polysaccharide is carboxy methyl cellulose.

4. The binder for the cathode of the Lithium-Sulfur battery as in claim 3, wherein the binder comprises approximately ⅔ carboxy methyl cellulose and ⅓ glucose by weight.

5. A cathode for a Lithium-Sulfur battery comprising Sulfur, Carbon and a binder, wherein the binder comprises approximately ⅔ carboxy methyl cellulose and ⅓ glucose by weight; wherein the Sulfur, the Carbon, and the binder are in ratios by weight of approximately 70% Sulfur, 20% Carbon, and 10% binder.

6. A method of making a cathode for a Lithium-Sulfur battery as in claim 5, wherein the cathode is made by the steps of:
a) dry mixing the Sulfur and the Carbon to form a first mixture;
b) stirring the first mixture;
c) adding the carboxy methyl cellulose and glucose to the first mixture to form a second mixture;
d) stirring the second mixture;
e) adding de-ionised water to the second mixture to form a slurry; and
f) forming the slurry into the cathode.

7. A Lithium-Sulfur battery comprising:
a cathode comprising Sulfur, Carbon and a binder, wherein the binder comprises approximately ⅔ carboxy methyl cellulose and ⅓ glucose by weight; wherein the Sulfur, the Carbon, and the binder are in ratios by weight of approximately 70% Sulfur, 20% Carbon, and 10% binder;
a Lithium anode;
a separator; and
a carbon nanotube paper interlayer.
